(19) United States
(12) Patent Application Publication
(10) Pub. No.: US 2026/0084900 A1
(43) Pub. Date: Mar. 26, 2026

(54) COMESTIBLE DISCHARGE WIRE CLEANING

(71) Applicant: Lawrence Equipment, Inc., South El Monte, CA (US)

(72) Inventor: Eric Clay Lawrence, Huntington Beach, CA (US)

(21) Appl. No.: 19/337,588

(22) Filed: Sep. 23, 2025

Related U.S. Application Data
(60) Provisional application No. 63/697,891, filed on Sep. 23, 2024.
(60) Provisional application No. 63/726,197, filed on Nov. 27, 2024.
(60) Provisional application No. 63/829,468, filed on Jun. 24, 2025.

(51) Int. Cl. B65G 45/14; A21C 9/08

(52) U.S. Cl. CPC B65G 45/14; A21C 9/08; B65G 2201/0202

(57) ABSTRACT

Methods, systems, and apparatus, including computer programs encoded on computer storage media, for using a discharge wire. A system can include a wire cleaning apparatus adapted to clean a discharge wire that is i) positioned within a threshold distance from a comestible conveyor belt and ii) adapted to remove comestibles from the comestible conveyor belt; and an actuator adapted to move the wire cleaning apparatus horizontally across the discharge wire during a cleaning process.

### CLAIM OF PRIORITY

This application claims priority under 35 USC § 119(e) to U.S. patent application Ser. No. 63/697,891, filed on Sep. 23, 2024, U.S. Patent Application Ser. No. 63/726,197, filed on Nov. 27, 2024, and U.S. Patent Application Ser. No. 63/829,468, filed on Jun. 24, 2025, the entire contents of which are hereby incorporated by reference.

### BACKGROUND

Examples of comestible products are flatbreads, which include, for example, tortillas, pita bread, pizza crusts, chapati, and naan. Flatbreads can be made by hand or with automated equipment. For example, a factory can produce one or more types of flatbread. Factories can use partially or fully automated systems to produce flatbread. Automated methods to form flatbread can include, for example, die cutting, sheeting, and pressing of flatbread dough.

Factories can include different types of tools or equipment for the different stages in the production process, such as a mixer, a sheeter or forming press, and an oven. Some production lines have tools to form flatbread dough into a ball and other tools to flatten the dough for baking. The flattened dough can have a circular shape and a specific thickness so the flatbread will have a desired thickness after baking.

### SUMMARY

In general, one aspect of the subject matter described in this specification can be embodied in systems that include a wire cleaning apparatus, e.g., that includes a wire cleaning head, adapted to clean a discharge wire that is i) positioned within a threshold distance from a comestible conveyor belt and ii) adapted to remove comestibles from the comestible conveyor belt; and an actuator adapted to move the wire cleaning apparatus horizontally across the discharge wire during a cleaning process.

In general, one aspect of the subject matter described in this specification can be embodied in systems that include a wire fixture adapted to attach, at a position on a support frame that is within a threshold distance from a comestible conveyor belt, a discharge wire that is adapted to remove comestibles from the comestible conveyor belt; and an actuator adapted to move the wire fixture horizontally across the discharge wire during a wire mounting process.

Other embodiments of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The subject matter described in this specification can be implemented in various implementations and may result in one or more of the following advantages. In some implementations, the systems and methods described in this specification can transfer comestibles more efficiently, more accurately, or both, compared to other systems. Either or both of these advantages can be provided by the use of a discharge wire, a wire cleaning apparatus, e.g., operating as a wire fixture, or both.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment that includes a conveyor belt.

FIG. 2 depicts an example system that includes a conveyor belt and a wire.

FIGS. 3A-C depict an example environment with a discontinuous conveyor belt and a forming tool.

FIGS. 4A-E depict an example environment with a conveyor belt that initially has two rows of apertures and on each end.

FIG. 5 is a flow diagram of an example process for forming a continuous conveyor belt.

FIGS. 6A-C and 7A-J depict an example of a portion of a comestible processing system.

FIGS. 8A-C depict example cleaning blades.

FIGS. 9A-C depict an example of a portion of a comestible processing system.

FIG. 10 depicts an example press that can be included in a comestible processing system.

FIG. 11 depicts an example of some devices that can be included in a flatbread processing system.

Like reference numbers and designations in the various drawings indicate like elements.

### DETAILED DESCRIPTION

Comestible processing systems can include conveyor belts to transfer comestibles between various tools in the comestible processing system. When forming a conveyor belt, a forming tool might try to square up the ends of the conveyor belt to improve tracking of the belt as the belt moves across supporting rollers. If the ends of the conveyor belt are not square within a threshold amount, e.g., not square enough, the conveyor belt does not track correctly and products on the belt might be transferred incorrectly, the conveyor belt might wear unevenly, or both. For instance, a comestible product near a longitudinal edge of a conveyor belt that isn't tracking correctly might fall off the longitudinal edge, run into a surface adjacent to the longitudinal edge, or, when transferring off of the conveyor belt, not align with a processing position on a downstream tool after the conveyor belt.

To better align the ends of a conveyor belt, a conveyor belt can include two rows of apertures. Each of the rows of apertures can be substantially parallel to the corresponding edge of the conveyor belt. A forming tool can insert pins into corresponding apertures from a first row and a second row to connect, e.g., weld, the two ends together. While the pins are inserted into corresponding apertures, the forming tool can connect regions between the pins, e.g., so as to not damage the pins. After connecting the regions between the pins, the forming tool can remove the pins and perform a second connection, e.g., welding, process to connect other corresponding regions that are adjacent to the apertures and were not connected during the first connection process. By using the rows of apertures, the forming tool can more accurately square the ends of the conveyor belt during the connection process, create a conveyor belt that more accurately tracks when moving across supporting rollers, or both.

When conveying comestibles, the conveyor belt can be part of a system that includes a wire, e.g., a discharge wire, adapted to remove comestibles from the conveyor belt. For instance, a pressing system can press comestibles while the comestibles are positioned on the conveyor belt, e.g., portions of the conveyor belt that are more than a threshold distance from the apertures and the regions of the conveyor belt that are connected. After pressing, the conveyor belt can transfer at least some of the comestibles to a downstream component, e.g., can transfer the correctly formed comestibles.

When the comestibles are “tender”, e.g., and have a viscoelastic property or an adhesive property that does not satisfy corresponding thresholds, the comestibles are more likely to be damaged, e.g., break or otherwise damaged, during the transfer process from the conveyor belt to the downstream component. For instance, gluten free comestibles can have a viscoelastic property that does not satisfy a viscoelastic threshold, an adhesive property that does not satisfy an adhesive threshold, or both. However, sometimes comestibles that are tender at certain stages in processing, e.g., after press and before baking in an oven, can have improved properties. The improved properties can be at the time the comestibles are tender; when finished, e.g., during, before or after packaging; or at another appropriate time.

To enable the conveyor belt, and the comestible processing system, to transfer tender comestibles, such as gluten free comestibles, the comestible processing system can use a wire adapted to remove the comestibles from the conveyor belt. The comestible processing system can include a support frame connected to the rollers on which the conveyor belt rests. The wire can be placed at least a threshold distance from the end of the support frame near which the comestibles are transferred from the conveyor belt to a downstream component. The wire can be a threshold distance from the conveyor belt. The threshold distance can be selected to increase a likelihood that comestibles removed from the conveyor belt are not damaged during the removal process.

In some implementations, the comestible processing system includes the conveyor belt and one or more actuators which are adapted to move the conveyor belt in a downstream direction. The amount of movement of the conveyor belt in the downstream direction can depend in part on a longitudinal distance of a press pattern (e.g., a length along the direction of movement of the conveyor belt) and a longitudinal distance of a seam in the conveyor belt, which seam is described in more detail below. The amount of movement, e.g., the index, can be selected such that a placement of the press pattern of comestibles does not overlap with a seam in the conveyor belt, e.g., which otherwise might result in a deformed comestible. An amount of movement can be, for example, 60 inches, 61.5 inches, 62.5 inches, 64.5 inches or the like.

In some implementations, by using the wire with the conveyor belt, the comestible processing system can increase a comestible processing rate. For example, when processing comestibles, the comestible processing system can move a conveyor belt at a speed sufficient to likely remove a comestible from the conveyor belt while also not likely damaging the comestible. Since slower speeds are necessary to reduce a likelihood of damaging a comestible, especially a tender comestible, the comestible processing system uses slower processing rates. By using a wire adapted to remove comestibles from the conveyor belt, the comestible processing system can have an increased comestible processing rate with substantially the same likelihood that comestibles will be damaged during transfer from the conveyor belt.

The comestible processing system can include a wire fixture. The wire fixture can position a wire, e.g., a discharge wire, in the comestible processing system. This can occur during the initial setup of the comestible processing system or at another appropriate time. For instance, the wire can be replaced periodically to reduce a likelihood of the wire breaking, e.g., due to use, or when the wire has broken.

The comestible processing system can include a wire cleaning apparatus. In some instances, the wire cleaning apparatus can be the same component or components as the wire fixture. The wire cleaning apparatus can clean the wire, e.g., remove debris buildup from the wire. This debris can build up on the wire as the wire removes comestibles from the conveyor belt. Since the comestibles might not be fully baked, e.g., might only be parbaked, some dough or other material, e.g., debris, from the comestibles might stick to the wire. The wire cleaning apparatus can remove at least some of this debris from the discharge wire. This can increase the efficiency in the wire removing comestibles from the conveyor belt, can reduce the likelihood that debris will be transferred to comestibles coming into contact with the discharge wire, or both.

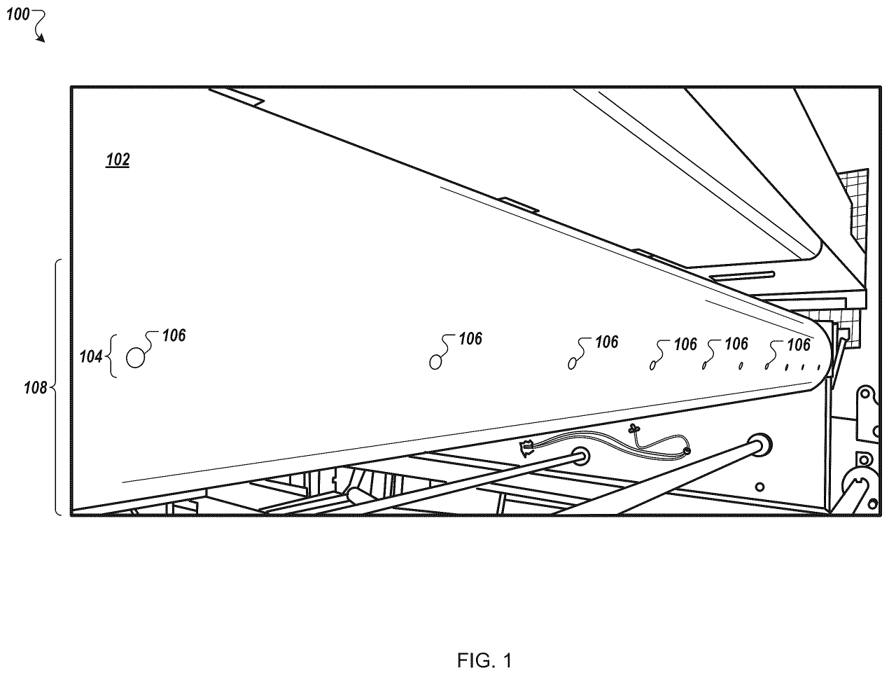

FIG. 1 depicts an example environment 100 that includes a conveyor belt 102. The conveyor belt 102 can be a lace-less conveyor belt in that the ends of the conveyor belt 102 are connected without the use of lace, e.g., Kevlar lace, or glue. Instead, the conveyor belt can be manufactured using a welding process as described in more detail below.

The conveyor belt 102 includes two rows 104 of apertures 106, each of which can be within a threshold distance of a corresponding latitudinal edge of the conveyor belt 102. As shown in FIG. 1, the two latitudinal edges of the conveyor belt 102 are connected, and the two rows 104 of apertures 106 are stacked on top of each other.

After the two latitudinal edges of the conveyor belt 102 are connected, the apertures can be left unfilled, e.g., other than any filling that might occur during the welding process. For example, if the apertures were filled, the filling might fall out, in part or in whole, during comestible transfer. To reduce a likelihood of contaminating transferred comestibles with any filling, the apertures can remain unfilled.

The conveyor belt 102 can be manufactured from any appropriate material for use transferring comestibles, e.g., flatbread whether baked or unbaked. For instance, the conveyor belt 102 can be manufactured from Teflon, fiberglass, silicon, or a combination of two or more of these.

The conveyor belt 102 can have a thickness between 2 to 20 mils, preferably between 5 to 12 mils, preferably 6.5 mils. Because a region 108 in which the two latitudinal ends of the conveyor belt 102 are connected, and that includes the two rows 104 of apertures 106, includes both latitudinal ends of the conveyor belt 102, the region 108 has a thickness that is greater than a thickness of the rest of the conveyor belt 102 when the ends of the conveyor belt 102 that form the region are not thinner than the rest of the conveyor belt 102. For instance, the region 108 can have a thickness between 4 to 40 mils when the other regions of the conveyor belt 102 have a thickness between 2 to 20 mils. In some examples, the region 108 can have a thickness between 10 to 24 mils, or a thickness of 13 mil.

Each of the ends of the conveyor belt 102 adjacent to the latitudinal edges can have a substantially consistent thickness. For instance, each of the latitudinal ends is not tapered.

In some examples, one or both of the ends of the conveyor belt 102 adjacent to the latitudinal edges can have a thickness different than the thickness of the rest of, e.g., a middle portion of, the conveyor belt 102. One or both of the latitudinal ends can be tapered. For instance, both edges can be tapered to reduce a thickness of the region 108 when the two ends are connected. In some examples, one or both of the latitudinal ends can thicken compared to the thickness of a middle portion of the conveyor belt.

The region 108 can be formed of the two latitudinal ends of the conveyor belt 102. The ends can have a threshold portion over which the two ends overlap. The threshold portion can have a length between ¼ to 4 inches.

A location of the rows 104 of apertures 106 can be selected using a thickness of the ends of the conveyor belt adjacent to the latitudinal edges, a material from which the conveyor belt 102 is manufactured, a diameter of the apertures, or a combination of two or more of these. For instance, the rows 104 of apertures 106 can be further from the latitudinal edges when the ends are tapered than if the ends have substantially consistent thicknesses, e.g., are not tapered.

The conveyor belt 102 can be adapted to convey comestibles, e.g., dough, pressed dough, or other types of flatbread during any processing stage. For instance, the conveyor belt 102 can convey comestibles from a flatbread press to an oven, described below in more detail.

Since the region 108 has the row 104 of apertures 106, a comestible processing system that includes the conveyor belt 102 might not use the region 108 to transfer comestibles. For instance, if the comestible processing system were to use the region 108 to transfer comestibles, those comestibles might have a higher likelihood of becoming damaged. This can occur during a press process when a comestible positioned on the conveyor belt 102 is pressed, which can transfer any imperfections or shapes from the conveyor belt 102 onto the comestible, such as an aperture or another shape created by connecting the overlapping ends of the conveyor belt.

In some implementations, the conveyor belt 102 can include one or more alignment markers (not shown). One example of alignment markers can include metal tabs. The comestible processing system can use the alignment markers when processing comestibles, e.g., to reduce a likelihood that comestibles are placed in the region 108. For instance, the conveyor belt 102 can include alignment markers before and after the region 108. The comestible processing system, e.g., a comestible press, can use a sensor to detect the alignment markers. If the detection of the alignment markers indicates that the region 108 is positioned to receive a comestible, the comestible processing system can move the conveyor belt 102 so that the region 108 is no longer positioned to receive comestibles.

By using the rows 104 of apertures 106 during the welding process, the conveyor belt 102 can be thinner than belts used in prior systems. For instance, comestible belts in prior systems can have a thickness around 26 mils, compared to the 2 to 20 mils for the conveyor belt 102. Further, prior systems can be combined using a lace that has a thickness of 9.5 mils, adding to the thickness of a region in which two ends of the belt are connected.

By having a thinner thickness, the conveyor belt 102 can improve comestible processing. For instance, when a component that includes the conveyor belt 102 changes a temperature of the conveyor belt 102, e.g., either by heating the conveyor belt 102 or cooling the conveyor belt 102, as part of comestible processing, the component can more quickly change the temperature of the conveyor belt 102 when the conveyor belt 102 is thinner than the conveyor belt would otherwise be. By more quickly changing temperature, the conveyor belt 102 can improve a shaping process of a carried comestible, a quality of a carried comestible, a production speed for carried comestibles, or a combination of these. For instance, when the conveyor belt 102 is part of a comestible press, pressed comestibles are more likely to maintain their pressed shape when the conveyor belt 102 is thinner and has better heat conductance.

In some implementations, the rows 104 of apertures 106 can be substantially parallel to the corresponding latitudinal edges closest to the corresponding row 104. This can enable a forming tool to align the corresponding apertures onto corresponding pins with a substantially even pressure on each of the apertures. The substantially even pressure can reduce a likelihood that a corresponding aperture will break, increase a likelihood that the two ends are squared correctly, or both.

For example, if some of the apertures 106 in a row 104 were different distances from the corresponding latitudinal edge, an alignment process of the two ends can create tension, put a different amount of pressure on walls surrounding different ones of the apertures, e.g., walls surrounding apertures closer to a latitudinal edge can have more pressure than walls surrounding apertures further from the latitudinal edge, or both. By having the rows 104 of apertures 106 substantially parallel to a corresponding latitudinal edge, e.g., such that the apertures 106 in a row 104 are all substantially the same distance from the corresponding latitudinal edge, the conveyor belt 102 can reduce tension during the process connecting the two ends in the region 108, can reduce any pressure differences on the walls surrounding the apertures in a row 104, or both.

In some implementations, the rows 104 of apertures 106 can each have three or more apertures. By having three or more apertures, there can be a reduced likelihood that the region 108 will have wrinkles when the two ends are connected. Wrinkles can reduce processing performance of the conveyor belt 102 in transporting comestibles. For instance, wrinkles can cause tracking problems in the movement of the conveyor belt 102, e.g., as part of the comestible processing system. Tracking problems can reduce a speed at which the conveyor belt 102 can move, reducing output of the comestible processing system that includes the conveyor belt.

The number of apertures 106 in a row 104 can be selected using a size, e.g., diameter, of the apertures, a width of the conveyor belt 102, a material from which the conveyor belt 102 is manufactured, a quantity of comestibles that the conveyor belt 102 will transfer at a time, e.g., either in a row 104 or in a processing grid layout, or a combination of two or more of these. For instance, to reduce a likelihood of wrinkles, a configuration system can select the number of apertures for the rows 104 of apertures 106 using one or more of the above mentioned parameters. The apertures 106 can have diameters between ¼ of an inch to 1 inch.

The region 108 in which the two ends of the conveyor belt 102 overlap can be any appropriate length. A system can select a size for the length using a property of the material from which the conveyor belt 102 is manufactured, e.g., a tensile strength, a thickness of the conveyor belt 102, a width of the conveyor belt 102, or a combination of two or more of these.

The conveyor belt 102 can have any appropriate width. For instance, the width can be between 24 or more inches, e.g., 24 to 60 inches, e.g., at least 52 inches, e.g., 52 inches or 60 inches. As the width of the conveyor belt 102 gets larger, any inaccuracies in the conveyor belt's 102 tracking are more pronounced. For example, a conveyor belt with a 30 inch width and a tracking inaccuracy can correctly transfer comestibles for a duration of time but a conveyor belt with a 60 inch width and the same tracking inaccuracy likely would be unable to operate for the same duration of time without breaking.

The conveyor belt 102 has two latitudinal edges. Each of the latitudinal edges can be substantially straight.

The conveyor belt 102 can be connected to a support frame. For instance, the conveyor belt 102 can connect with one or more rollers. Each of the rollers can be mounted onto the support frame. Some of the rollers can be passive. Some of the rollers can be powered to rotate, e.g., by an actuator.

In some implementations, the support frame or another component in the comestible processing system can include a forming tool, described in more detail below. The forming tool can connect the two ends of the conveyor belt 102. The forming tool can include a row of pins. The support frame can position the two rows 104 of apertures 106 so that the apertures 106 substantially align with the row of pins. For instance, each of the pins in the row of pins aligns with a corresponding aperture from each of the rows 104 of apertures 106, e.g., aligns with two apertures, one from the first row 104 and another from the second row 104.

When the two rows 104 of apertures 106 are substantially aligned with the row of pins, the forming tool can extend the pins into the apertures. By extending the pins into the apertures, the forming tool can substantially square the two ends of the conveyor belt 102.

While the pins are extended into the apertures, the forming tool can connect the two ends of the conveyor belt 102 as described in more detail below. For instance, the forming tool can weld the two ends together.

When the connection process is complete, the forming tool can retract the pins from the apertures. The forming tool can maintain the pins in the retracted position while the comestible processing system processes comestibles using the conveyor belt 102. For instance, when the support frame is a support frame for a comestible press, the forming tool can maintain the pins in the retracted position while the conveyor belt 102 receives comestible balls, a comestible press presses the comestible balls, and the conveyor belt 102 transfers the pressed comestibles to a downstream component.

The conveyor belt 102 can be included in any appropriate component in a comestible processing system. For example, the conveyor belt 102 can be part of a comestible press, a monitoring station, a counter-stacker, or a separate conveyor that transfers comestibles between other components.

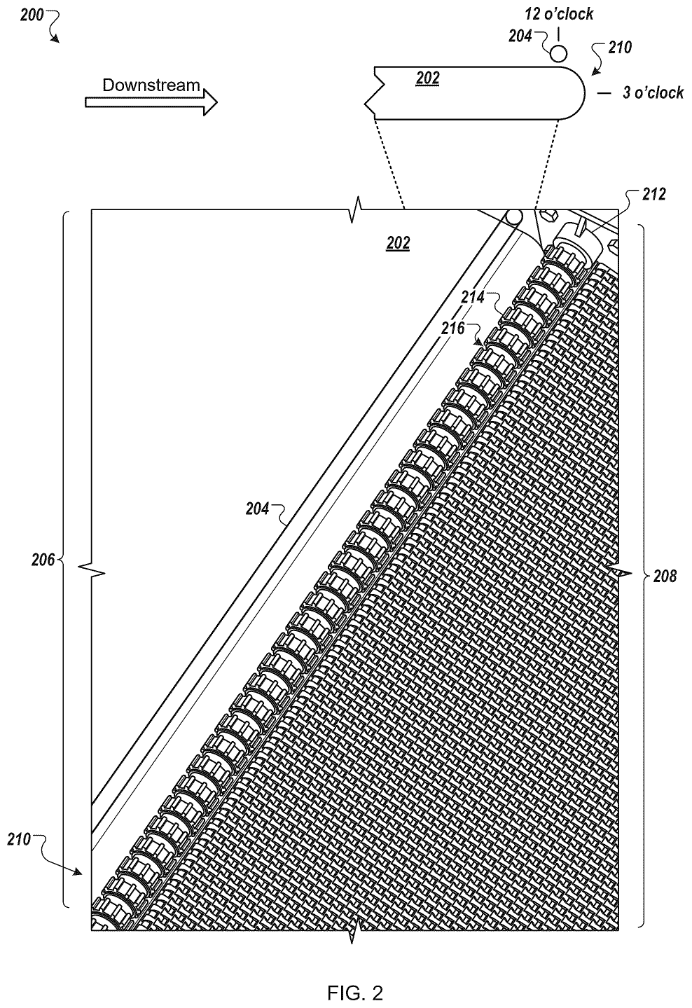

FIG. 2 depicts an example system 200 that includes a conveyor belt 202 and a wire 204. The conveyor belt 202 can be the conveyor belt 102 described above with reference to FIG. 1. The wire 204 can be an example of a discharge wire. For instance, the system 200 can use the wire 204 to remove comestibles from the conveyor belt 202.

For example, the system 200 can use the conveyor belt 202 to transfer comestibles from a first component 206 to a downstream component 208. In this example, the downstream component 208 is another conveyor. When the first component 206 is a comestible press, the downstream component 208 can be the other conveyor used to transfer comestibles from the comestible press to an oven.

The system 200 can use the wire 204 to remove comestibles from the conveyor belt 202. For instance, comestibles might stick to the conveyor belt 202 without the use of the wire 204, fall between sequential conveyor belts, or both. By using the wire 204, the system 200 can reduce a likelihood that comestibles will stick to the conveyor belt 202, fall, or both, when the comestibles are being transferred to the downstream component 208.

The wire 204 can be any appropriate distance from the conveyor belt 202. For instance, the wire 204 can be between 2/1000 of an inch and 5 includes, preferably between 2/1000 of an inch ½ an inch or ¼ of an include and 5 inches, from the outer surface of the conveyor belt 202. In some examples, the wire 204 is about 3/16 of an inch from the outer surface of the conveyor belt 202.

The wire 204 can have a thickness between 10 to 80 mils, e.g., between 10 to 50 mils. For instance, the wire 204 can have a thickness between 10 and 32 mils, preferably 19 or 20 mils.

The wire 204 can have any appropriate tension along at least a portion of its length. For example, the wire fixture can apply a tension across at least a portion of the wire 204. The tension can be selected so that the wire 204 does not drag on a surface below the wire, e.g., the conveyor belt 202; does not break; or both. For instance, the wire 204 can have a tension of 50 to 120 pounds per inch (“PSI”), 50 to 100 PSI, or any other appropriate tension. The tension can be selected given the thickness of the wire 204.

The wire 204 can be positioned toward a discharge end 210 of the conveyor belt 202. The wire 204 can be at any appropriate position with respect to the discharge end 210 of the conveyor belt 202. For instance, the wire 204 can be between 11:55 o'clock and 3 o'clock, or 12 o'clock and 3 o'clock with respect to the discharge end 210. The wire 204 can be between 11:55 o'clock and 1 o'clock, or 12 o'clock and 1 o'clock, e.g., 12:30. In some examples, the wire 204 can be within a threshold distance below 12 o'clock that is closer to 12 o'clock than 1 o'clock, e.g., between 12 and 12:05 o'clock, or between 11:55 and 12 o'clock.

A configuration system can select the position of the wire 204, a distance of the wire 204 from an outer surface of the conveyor belt 202, a tension on the wire 204, or any combination of these, using any appropriate parameter. For instance, the configuration system can select the position of the wire 204, the distance of the wire 204 from the outer surface of the conveyor belt 202, or both, using a geometry of the conveyor belt 202, e.g., when installed in a support frame or another component in a comestible processing system; a geometric of a the downstream component 208 to which comestibles are transferred; a predicted inertia of a comestible transported by the conveyor belt 202; properties of the comestible such as a viscosity of the comestible; properties of the material from which the conveyor belt 202 is manufactured; or a combination of two or more of these.

Because the system 200 includes the wire 204, the system 200 need not include a roller, e.g., with one or more flapper attachments, adapted to move comestibles from the conveyor belt 202 to the downstream component 208. For example, the roller could be used to guide comestibles from the conveyor belt 202 onto the downstream component 208 using the one or more flapper attachments.

The use of the wire 204 instead of other components, such as a roller with one or more flapper attachments, can increase comestible uniformity; reduce damage to a comestible, e.g., caused by a roller with one or more flapper attachments; enable improved temperature control; or any combination of these. The improved temperature control can be provided by the wire 204 allowing for lower temperatures, lower energy usage, or both, than using no wire and a roller with the one or more flapper attachments. The wire can have an increased likelihood of not damaging a comestible during a transfer process between the conveyor belt 202 and the downstream component 208, e.g., a reduced likelihood of flipping or otherwise jamming a comestible, a reduced likelihood of causing direct damage to a comestible such as a dent in the surface of the comestible, or both. The improved temperature control can result in improved comestible uniformity, a wider variety of recipes for processing the comestibles, or both.

In some implementations, the system 200 can use one or more blowers (not shown) to blow air onto bottoms of at least some comestibles when the comestibles are transferred from the conveyor belt 202 to the downstream component 208. The blowers can blow a stream of air upward toward the bottoms of comestibles to reduce a likelihood that the comestibles will land in an aperture, e.g., a gap, between the conveyor belt 202 and the downstream component 208. The blowers can blow a continuous stream of air, intermittently blow air, or a combination of both.

In some implementations, the system 200 does not include a cantilevered head frame onto which the conveyor belt 202 is placed. For instance, when the first component 206 is a comestible press, given the weight of the press head, the conveyor belt 202 is placed on a support frame that does not include a cantilevered head. This is done so that the support frame can support the weight of the press head.

In some implementations, the system 200 can include a wire cleaning apparatus. The system 200 can use the wire cleaning apparatus to clean the wire 204. Cleaning the wire 204 can reduce the risk of obstructions forming at the wire 204, e.g., due to buildup of material on the wire 204.

The wire cleaning apparatus can include a wire cleaning head, one or more actuators, one or more controllers, one or more sensors, or a combination of two or more of these. Each of the one or more controllers can be a data processing apparatus, e.g., that includes electronic circuitry. The wire cleaning apparatus can include one or more guide rails, arranged to translate the wire cleaning apparatus with respect to the wire. The wire cleaning apparatus can include on or more adjustable mounts, configurable to adjust a position of the wire, wire cleaning head, or both with respect to the conveyor belt, e.g., during a wire cleaning process.

The wire cleaning head can be any appropriate type of cleaning head. Some examples of the cleaning head can include a wire, e.g., a twisted wire, a wire loop, or both; or a bar. When the cleaning head is a wire loop, the wire loop can, e.g., moveably, encircle the wire 204. When the wire loop moves along the substantially horizontal length of the wire 204, the wire loop can remove debris from the wire 204 as part of the cleaning process. The wire cleaning head can include bristles, a comb, other types of filaments, or any combination of these, arranged to agitate debris accumulated on the wire during the wire cleaning process.

The wire cleaning apparatus can include any appropriate number of actuators. The one or more actuators can each be a servo that moves a corresponding component to which the servo is attached. A first actuator can move the wire cleaning head in a horizontal direction across the wire 204, e.g., laterally between the two sides of the wire and the system 200.

A second actuator can move the wire cleaning head to contact the wire 204, e.g., in implementations in which the wire cleaning apparatus is not always coupled with the wire 204. For instance, when the wire cleaning apparatus is not actively cleaning the wire 204, the second actuator can maintain the wire cleaning head away from the wire 204, e.g., a threshold distance from the wire 204. When a controller determines that the system 200 should perform a wire cleaning process, the second actuator is adapted to move the wire cleaning head of the wire cleaning apparatus to a cleaning position. The cleaning position can be a position in which the wire cleaning head contacts the wire 204 or is otherwise at a location to clean the wire 204. The first actuator can move the wire cleaning head across the wire 204, e.g., to perform the cleaning operation along the length of the wire 204. This can increase a likelihood that material that built up on the wire 204 is removed from the wire 204, which can decrease the likelihood of an obstruction forming at the wire 204. After the cleaning operation, the second actuator can move the wire cleaning head away from the wire 204.

A third actuator can move the wire cleaning apparatus and wire 204 from a first position, e.g., a normal operation position, to a second position, e.g., a cleaning position. The normal operation position can be where the wire cleaning head of the wire cleaning apparatus is located in an offset position, e.g., away from the conveyor belt, and the wire is located at a lowered position with respect to the conveyor belt, e.g., to remove comestibles from the conveyor belt. The cleaning position can be where the wire and the wire cleaning apparatus are raised to an elevated position from the conveyor belt, e.g., away from the surface of the conveyor belt. Optionally, the cleaning position can be where the wire and the wire cleaning apparatus are laterally translated to be oriented over a gap, e.g., an aperture, between the conveyor belt and the downstream component.

In some instances, the system 200 includes one or more additional actuators configured to move the conveyor belt, the downstream component, or both along the longitudinal axis of the conveyor belt. The one or more additional actuators can selectively separate, e.g., in response to a signal to perform a removal operation, the conveyor belt and downstream component away from each other to open or widen the gap, e.g., the aperture, between the edge of the conveyor belt and the downstream component.

The one or more controllers can include any appropriate number of controllers. In some examples, at least some of the controllers can be part of a single controller. A first controller can trigger the cleaning process. The first controller can receive a signal from another component in the system 200, e.g., a master controller, that indicates that the cleaning process should be performed. In some examples, the first controller is the master controller that determines that the cleaning process should be performed. The cleaning process can be performed according to a press cycle, e.g., after each press cycle, or every other press cycle. In some examples, the cleaning process can be performed based on an amount of material detected on the wire 204, e.g., responsive to sensor data from one or more sensors.

The one or more controllers can include a second controller that stops at least a portion of the system 200 upon detection of an obstruction at the wire 204. The obstruction can include a comestible or group of comestibles that is stuck on the wire. For instance, the system 200 can include a sensor, e.g., a laser photo eye or camera, that monitors the wire 204, e.g., at least a portion of the length of the wire.

The system 200 can include a sensor, e.g., the same sensor or a different sensor, that can detect a deformation in the discharge wire. A deformation can include, for example, a bent wire, broken wire, distended wire, or any combination of these. A deformation can be a wire condition in which an efficacy of the discharge wire to remove comestibles from the conveyer does not satisfy, e.g., is less than, a threshold value. The sensor can be configured to detect the deformation in the discharge wire and, in response to detecting the deformation, can transmit to a controller, e.g., the second controller, a signal that indicates the discharge wire is deformed. In some implementations, the second controller can obtain, from the sensor, sensor data indicative of the wire deformation, process the sensor data, and determine, from the processed sensor data that the wire is deformed. The sensor can be part of one or more sensors that monitor the discharge wire.

In some implementations, upon determining a deformation of the discharge wire, the second controller provides, to a device optionally operated by a human operator, an alert related to the deformation. The alert can include a visual indication of the deformation, e.g., a photo or video captured of the deformation. In some examples, the alert can include instructions with one or more steps to rectify the issue. In some instances, the system can engage with an automated or semi-automated repair protocol to initiate a repair of the deformed discharge wire.

In some instances, the sensor can monitor a portion of the length or an entire length of the wire 204 across the conveyor belt 202. When the sensor detects an obstruction, e.g., a jam, the sensor can transmit a signal that indicates the obstruction to a second controller, e.g., the master controller. In response, the second controller can stop one or more portions of the system 200, e.g., the comestible processing system such as the flatbread processing system 1100 described in more detail below. For instance, the second controller can stop the comestible press and optionally other parts of, e.g., all of, the comestible processing system.

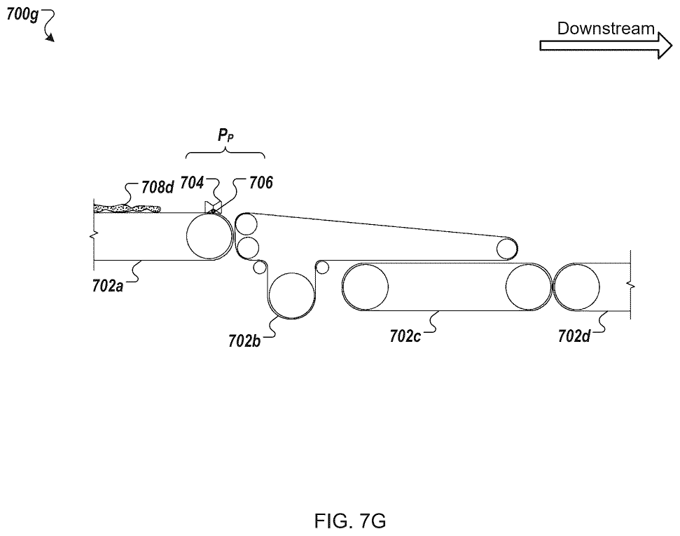

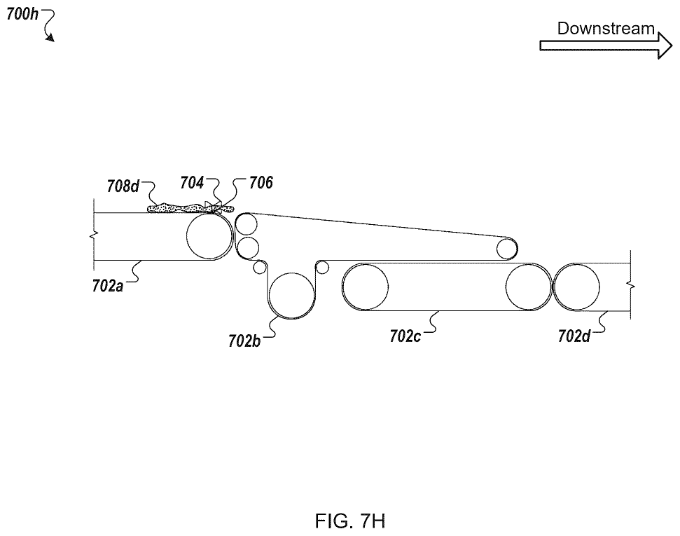

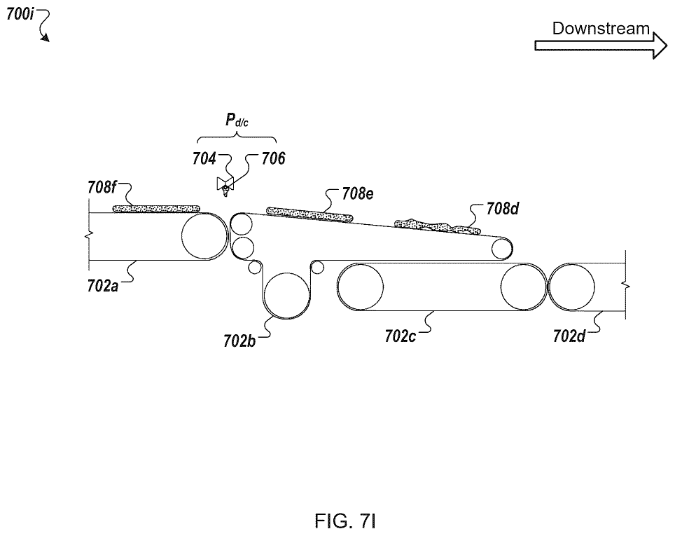

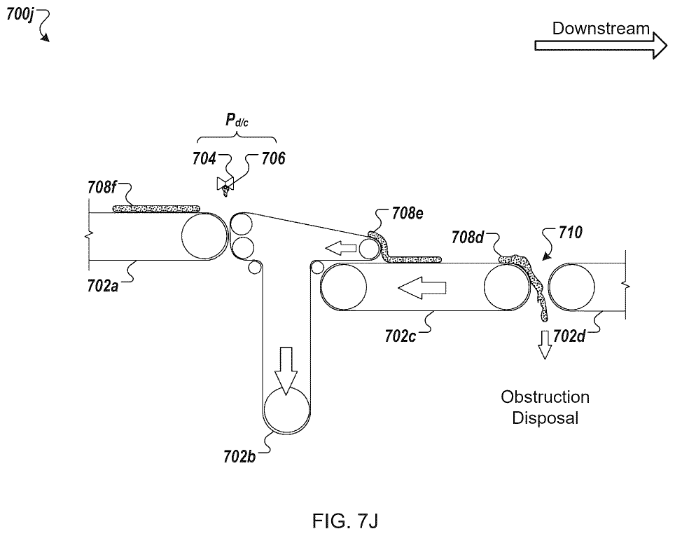

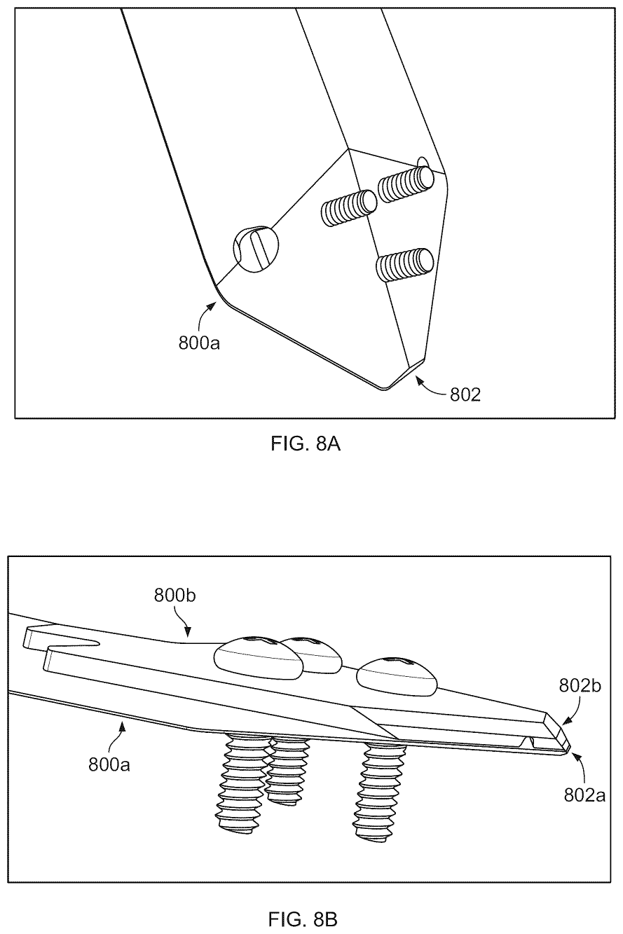

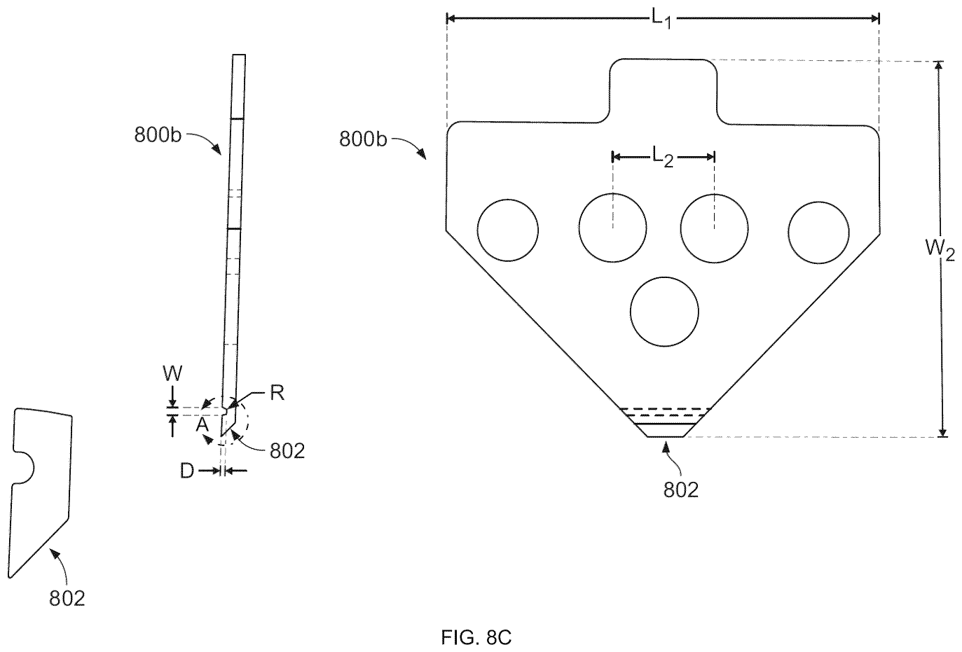

In some implementations, the second controller can trigger a process to remove the obstruction. For example, the second controller can adjust a position, e.g., lateral, vertical, angle, or any combination of these, of the conveyor belt, the downstream component, or both, to allow the obstruction to be moved manually or by an automated process. In some instances, the second controller can generate an alert to notify an operator of the obstruction. Further details related to an obstruction removal process are described with reference to FIGS. 8A-C.

In some implementations, the system 200 can include a wire fixture. The system 200 can use the wire fixture to attach the wire 204 to a support frame included in the system. The support frame can be a frame that couples to and supports the conveyor belt 202. The support frame can include two sides. Each side of the support frame can couple to a corresponding end of the wire.

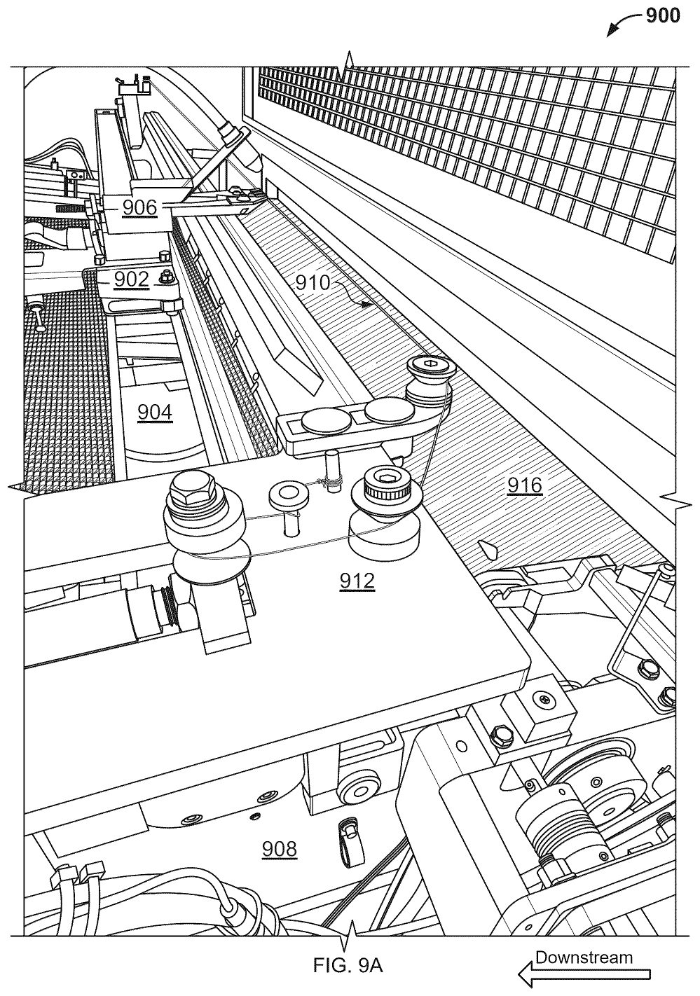

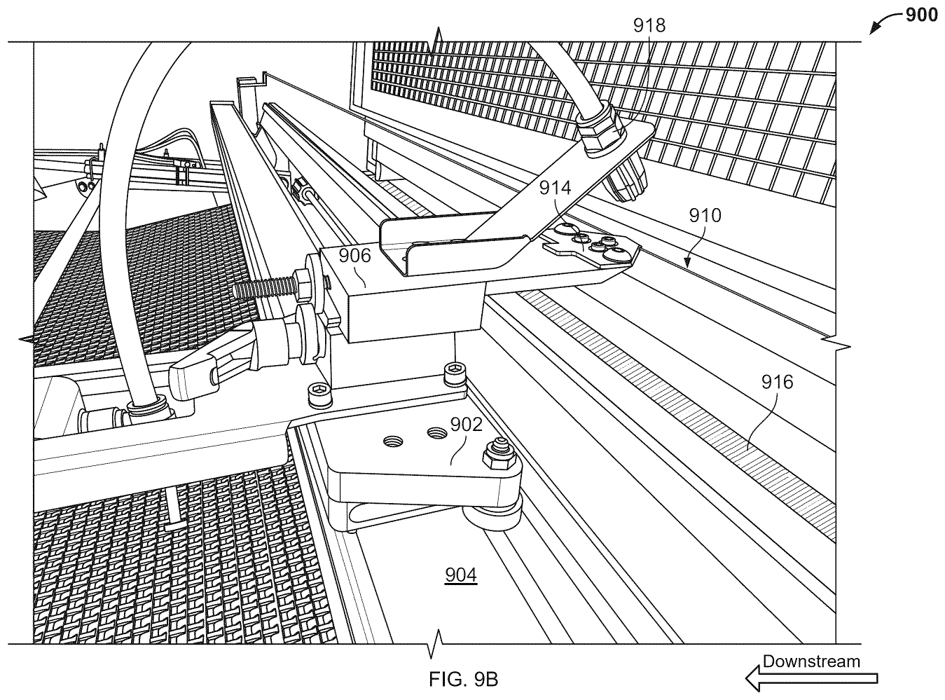

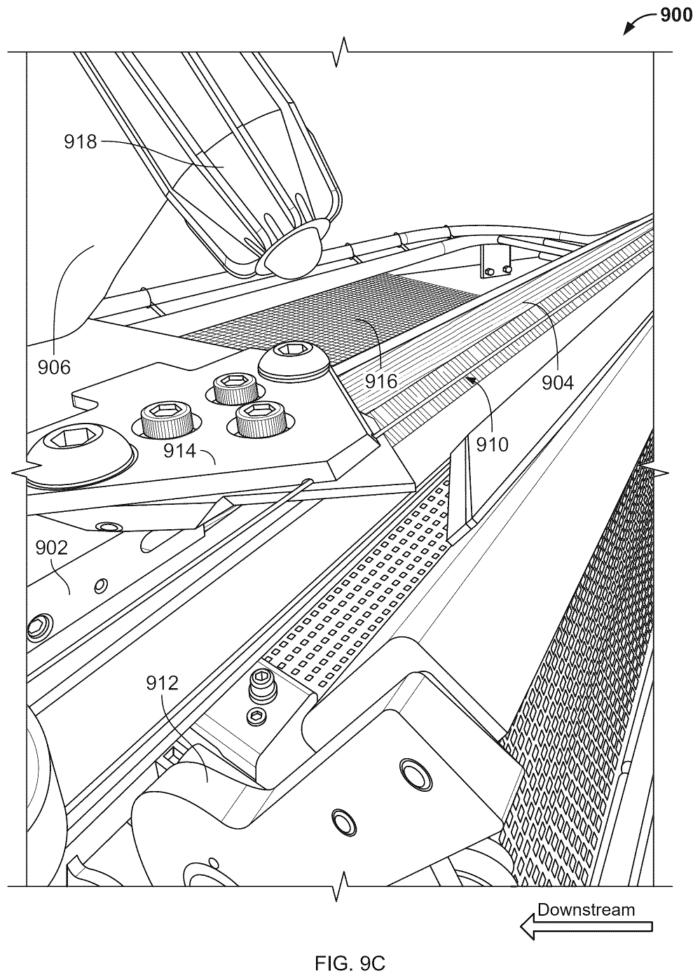

The wire fixture can include one or more points of contact with the wire, e.g., to adjust a position of the wire with respect to the conveyor belt, to adjust a tension of the wire, or a combination of both. The wire fixture can be a unitary component or can include multiple, e.g., two or more, subcomponents. The components of the wire fixture can be manufactured from, for example, materials selected to be compatible with food processing equipment and sufficiently resilient to resist wear over a given period of time. For example, the wire fixture can be stainless steel, titanium, or other high strength, low contaminant metals. The support frame can include a wire fixture that has one or more bars and a hook on each side. The wire 204 can wrap around at least one of the bars and couple with the hook. The coupling can be any appropriate type of coupling, e.g., wrapping around the hook, welded onto the hook, another appropriate type of coupling, or any combination of these. In some instances, at least one of the bars can be used to maintain a position of the wire with respect to the conveyor belt 202. Further details of the wire fixture described below with reference to FIG. 9A.

The system 200 can include a connection module that couples the wire 204 to at least one of the sides of the support frame. The connection module can be any appropriate type of device, such as an air cylinder, a pneumatic cylinder, a hydraulic cylinder, a second actuator, or any combination of these.

The system 200 can include the wire fixture, one or more actuators, one or more controllers, one or more sensors, or a combination of two or more of these. Each of the one or more controllers can be a data processing apparatus, e.g., that includes electronic circuitry.

The wire fixture can be any appropriate type of mounting fixture. For example, the wire fixture can include an eye or another form of aperture through which the wire 204 is placed. As the wire fixture moves across the conveyor belt, during a wire mounting process, the wire 204 can feed through the wire fixture.

The wire fixture can include a coupling mechanism that prevents the wire 204 from falling out of the wire fixture. The coupling mechanism can be any appropriate type of device. For instance, the coupling mechanism can be an aperture that is smaller than a diameter of an end portion of the wire 204. The coupling mechanism can be a clamp or another type of mechanism configured to retain an end portion of the wire 204.

The wire fixture can couple to any appropriate number of actuators. The one or more actuators can each be a servo that moves a corresponding component to which the servo is attached. For example, an actuator can move the wire fixture in a horizontal direction across the wire 204, e.g., between the two sides of the support frame and the system 200, as part of the wire mounting process.

The one or more controllers can include any appropriate number of controllers. In some examples, at least some of the controllers can be part of a single controller. A first controller can trigger the wire mounting process. The first controller can receive a signal from another component in the system 200, e.g., a master controller, that indicates that the wire mounting process should be performed. In some examples, the first controller is the master controller that determines that the wire mounting process should be performed. The wire mounting process can be performed according to a press cycle, e.g., after a predetermined number of press cycles, or in response to a signal from a sensor, e.g., that detects that a previously mounted wire broke.

The one or more controllers can include a second controller that stops at least a portion of the system 200 upon detection of a break in the wire 204. For instance, the system 200 can include a sensor, e.g., a laser photo eye, that monitors the wire 204, e.g., at least a portion of the length of the wire. The system 200 can include a sensor that monitors a tension across the wire 204. In some instances, the sensor can monitor the entire length of the wire 204 across the conveyor belt 202. When the sensor detects a break in the wire, the sensor can transmit a signal that indicates the break to a second controller, e.g., the master controller, the first controller, or both. In response, the second controller can stop one or more portions of the system 200, e.g., the comestible processing system such as the flatbread processing system 1100 described in more detail below. In some instances, the second controller can stop the comestible press and optionally other parts of, e.g., all of, the comestible processing system.

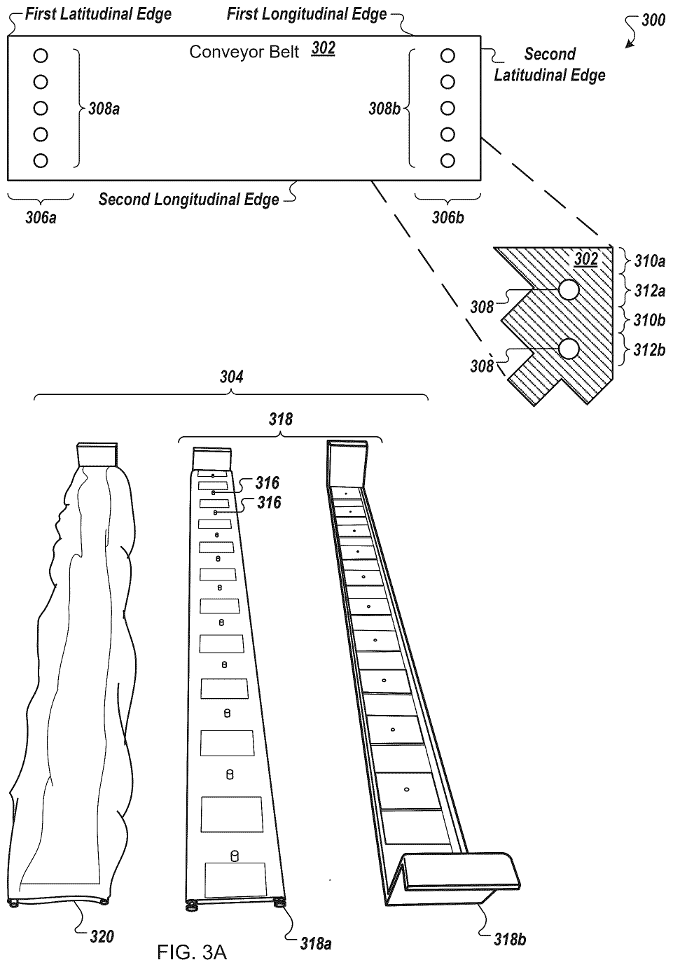

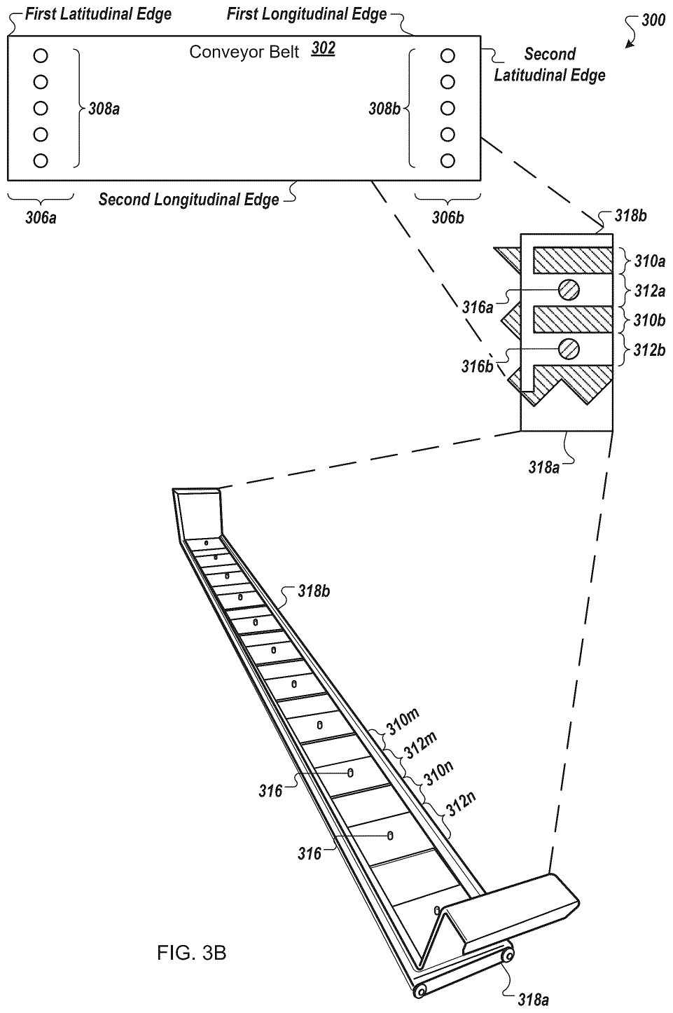

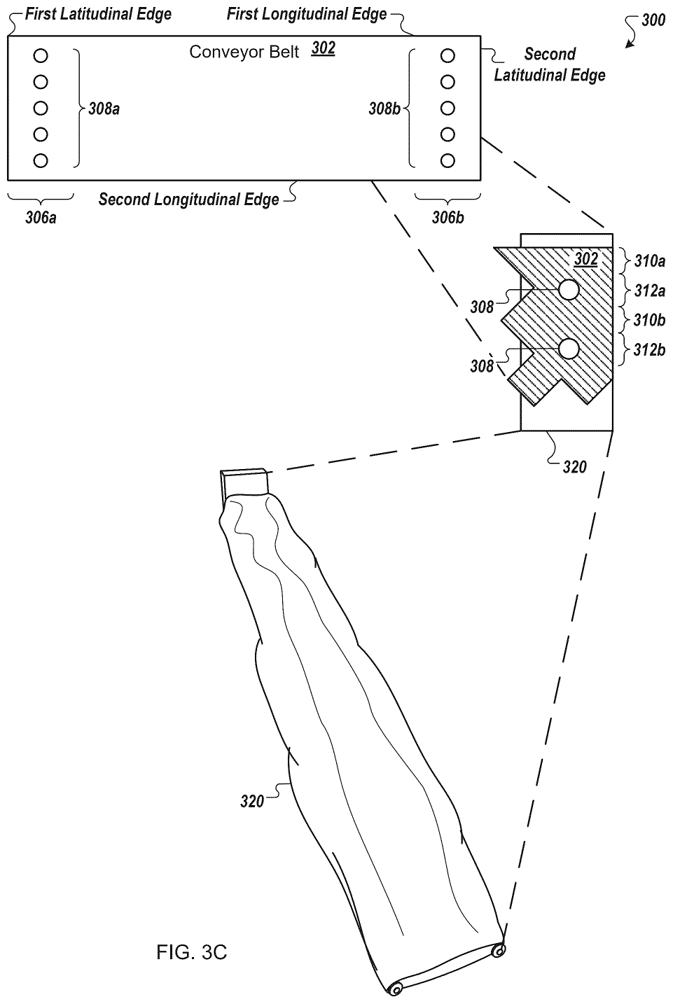

FIGS. 3A-C depict an example environment 300 with a discontinuous conveyor belt 302 and a forming tool 304. A comestible processing system can use the forming tool 304 to connect two ends 306a-b of the discontinuous conveyor belt 302, that includes rows of apertures 308a-b, to form a continuous conveyor belt, e.g., the conveyor belt 102 or 202. For instance, a comestible press can include the forming tool 304 to create continuous conveyor belts.

In some examples, the forming tool 304 includes an alignment subcomponent 318 and a welding platform 320. The alignment subcomponent 318 can include a guide 318a and a securing bracket 318b.

During the continuous conveyor belt forming process, the forming tool 304 can receive the two ends 306a-b of the conveyor belt 302. The forming tool 304 can place the rows of apertures 308a-b over pins 316a-b included in the alignment subcomponent 318, as shown in FIG. 3B. For instance, the forming tool can align a first row of apertures 308a with a second row of aperture 308b. This alignment process can include placing corresponding pins 316a-b included in the guide 318a through the corresponding apertures 308 from the two rows of apertures 308a-b. As depicted in the top right corner of FIG. 3B, the guide 318a is below the conveyor belt 302, e.g., below the two ends 306a-b.

The pins 316a-b can have a diameter selected to fit into the corresponding apertures 308. For instance, when the apertures 308 have a diameter between ¼ of an inch to an inch, the pins 316a-b can have substantially the same diameter selected from between ¼ of an inch to an inch. The diameters of the pins 316a-b can be selected to that the pins 316a-b fit tightly in the apertures 308, e.g., reducing a likelihood that the pins 316a-b will move when placed inside corresponding apertures 308.

The ends of the pins 316a-b that pass through the apertures 308 can be manufactured to enable to pins 316a-b to be easily inserted into the apertures 308 before the pins fit tightly in the apertures 308. For instance, the ends of the pins 316a-b can be rounded, pointed, or have another appropriate shape.

The forming tool 304 can place the securing bracket 318b on top of the two ends 306a-b of the conveyor belt 302. This can form a stack that includes the guide 318a at the bottom, the two ends 306a-b of the conveyor belt 302 in the middle, e.g., in either order, and the securing bracket 318b on the top.

Placement of the securing bracket 318b on top of the two ends 306a-b of the conveyor belt 302 can create multiple regions for each of the two ends 306a-b. For instance, by placing the securing bracket 318b on top of the two ends 306a-b, the forming tool 304 can create multiple initial welding regions 310a-n and multiple apertures surrounding regions 312a-n. The forming tool 304 can then weld some of the regions and then weld the other regions, e.g., as part of a stitch welding process of the two ends 306a-b. For instance, the forming tool 304 can position a heating device on top of the two ends 306a-b to weld the regions together.

Each of the aperture surrounding regions 312a-n can surround and be adjacent to an aperture included in the corresponding end 306a-b of the conveyor belt 302. For example, a first aperture surrounding region 312a can surround and be adjacent to a first aperture through which a first pin 316a passes.

The multiple initial welding regions 310a-n can be between sequential aperture surrounding regions 312a-n. For instance, a first initial welding region 310b can be between the first aperture surrounding region 312a and a second aperture surrounding region 312b.

The multiple initial welding regions 310a-n can include one or more additional regions that are not between sequential apertures surrounding regions 312a-n. For example, the multiple initial welding regions 310a-n can include an end initial welding region 310a that is positioned along a first longitudinal edge of the conveyor belt 302.

While the two rows of apertures 308a-b are aligned, e.g., on the guide 318a, the forming tool 304 welds at least some regions of the two ends 306a-b together. For instance, the forming tool 304 can weld corresponding initial welding regions 310a-n together with a heating device positioned on top of the initial welding regions 310a-n formed by the securing bracket 318b. When the conveyor belt 302, and the two ends 306a-b, are manufactured of Teflon, e.g., with fiberglass, the forming tool can heat the initial welding regions 310a-n to a temperature between 450 and 475° F. to connect the corresponding initial welding regions 310a-n from the two ends 306a-b of the conveyor belt 302.

The two ends 306a-b can be welded together using any appropriate material. For instance, the welding process can include welding the two ends 306a-b together with the use of an adhesive between at least portions of the two ends 306a-b. The portions between which the adhesive is located can include portions of the two ends 306a-b other than the rows of apertures 308a-b. The adhesive can be a Teflon tape. The adhesive can have a thickness of 3.5 mils. In some implementations, the welding process can use the adhesive when a thickness of the two ends does not satisfy a thickness threshold, e.g., is less than a thickness threshold. In some examples, the welding process does not include the use of any adhesive and only includes the heating process of the two ends 306a-b.

The forming tool 304 can weld the initial welding regions 310a-n for any appropriate period of time. A configuration system can determine a duration for the period of time using the material from which the conveyor belt 302 is manufactured, a thickness of the ends 306a-b, a size of the initial welding regions 310a-n, or a combination of two or more of these.

In some implementations, the securing bracket 318b can have a weight selected to increase a likelihood that the ends 306a-b are flat while positioned on top of the guide 318a. By increasing a likelihood that the ends 306a-b are flat, the securing bracket 318b can reduce a likelihood that the two ends, when connected, do not have any wrinkles, increase a processing throughput, speed, or both, of the continuous conveyor, or a combination of these.

After welding the initial welding regions 310a-n, the forming tool 304 can remove the alignment subcomponent 318 from the conveyor belt 302 and place the ends 306a-b on top of the welding platform 320, as shown in FIG. 3C. For example, the forming tool 304 can retract the pins 316a-b from the apertures 308a-b, remove the guide 318a from behind the conveyor belt 302, and remove the securing bracket 318b from on top of the conveyor belt 302. The forming tool 304 can place the ends 306a-b on top of the welding platform 320 by moving the welding platform 320 to a position behind the ends 306a-b. The position behind the ends 306a-b can be substantially the same position in which the forming tool 304 positioned the guide 318a.

The forming tool 304 can weld the ends 306a-b of the conveyor belt 302 together, e.g., by placing a heating device on top of the ends 306a-b. The heating device can heat the ends 306a-b to a temperature between 450 and 475° F.

The heating device can weld any appropriate corresponding regions from the two ends 306a-b together. In some examples, the heating device welds only corresponding aperture surrounding regions 312a-n from the two ends 306a-b together. In some implementations, the heating device welds corresponding aperture surrounding regions 312a-n from the two ends 306a-b together while completing a welding process for the initial welding regions 310a-n.

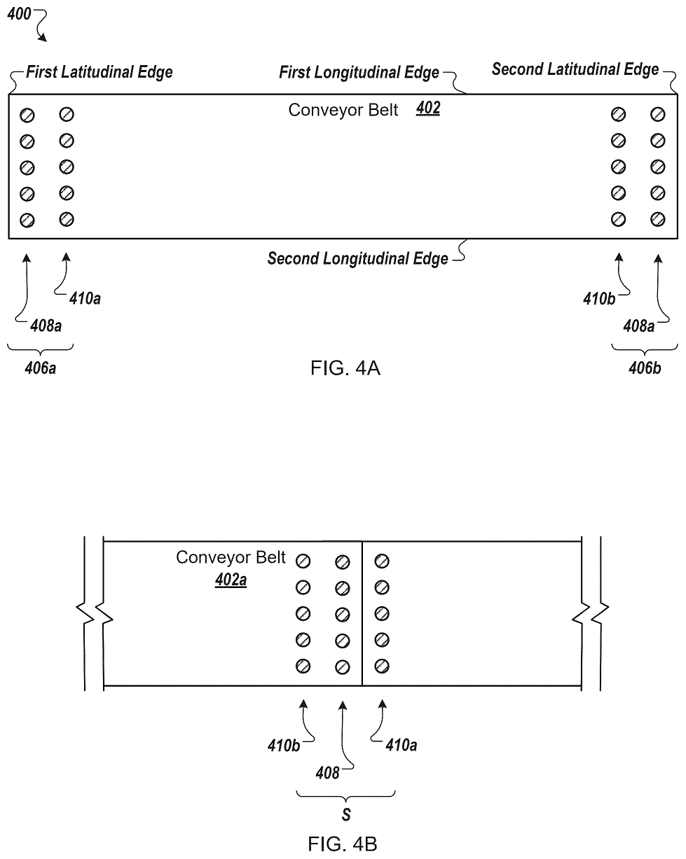

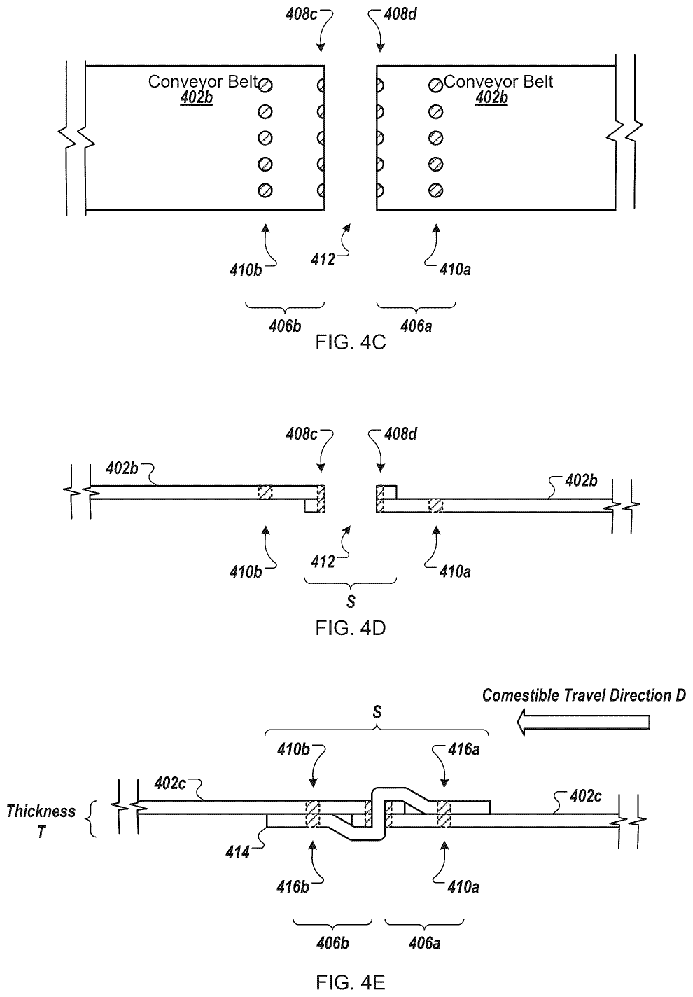

FIGS. 4A-E depict an example environment 400 with a conveyor belt 402 that initially has two rows of apertures 408a-b and 410a-b on each end 406a-b. A comestible processing system can use the second rows of apertures 410a-b in the conveyor belt 402 to form a rejoined belt after the conveyor belt 402 is removed from the comestible processing system. FIGS. 4A-C depict a plan view of the conveyor belt 402 at different times, while FIGS. 4D-E depict an elevation view of the conveyor belt 402 at different times.

For example, the environment 400 can be the environment 300, with the conveyor belt 402 being a version of the conveyor belt 302 with second rows of apertures 410a-b at each end 406a-b. A comestible processing system, e.g., a comestible press, can use the conveyor belt 402, depicted in FIG. 4A, to initially form a continuous conveyor belt 402a, depicted in FIG. 4B, similar to the process described above with reference to FIGS. 3A-C. In FIG. 4B, the conveyor belt 402 can include a seam region S that includes the apertures 408 and 410. This region can be thicker than the rest of the conveyor belt, e.g., as shown by the sides of the conveyor belt 402 near the cut 412 in FIG. 4D, described in more detail below; the portion of the conveyor belt 402 with the splice piece 414, described in FIG. 4E; or both.

As the continuous conveyor belt 402a is used to convey comestibles, the continuous conveyor belt 402a can get dirty. For instance, dough or other particles from comestibles transported by the continuous conveyor belt 402a can stick to the continuous conveyor belt 402a.

To clean the continuous conveyor belt 402a, the continuous conveyor belt 402a might need to be removed from the comestible processing system, e.g., from the comestible press. To remove the continuous conveyor belt 402a, the comestible processing system can cut the continuous conveyor belt 402a, forming a cut conveyor belt 402b with a cut 412 between the two ends 406a-b of the cut conveyor belt 402b, as depicted in FIGS. 4C-D.

The comestible processing system can form the cut 412 in the continuous conveyor belt 402a approximately in the center of the first rows of apertures 408a-b that are overlapping. For instance, as described in more detail above, to form the continuous conveyor belt 402a, the pair of first rows of apertures 408a-b are placed approximately on top of each other. The two ends of the belt 406a-b are then connected. When the continuous conveyor belt 402a needs to be cleaned, the comestible processing system can form a latitudinal cut 412 in the continuous conveyor belt 402a.

The comestible processing system can use any appropriate process to form the cut 412 in the continuous conveyor belt 402a. The comestible processing system can include a blade used to form the cut 412. In some examples, an external tool, e.g., held by an engineer, can be used to form the latitudinal cut.

FIG. 4D depicts an elevation view of the cut conveyor belt 402b that aligns with the plan view depicted in FIG. 4C. For instance, the second row of apertures 410a-b is depicted with the dashed lines and cross-hatching. The left and right sides of the cut first row of apertures 408c-d is similarly depicted.

After the cut conveyor belt 402b is cut, the cut conveyor belt 402b can be removed from an apparatus in the comestible processing system to which it was attached. For instance, the cut conveyor belt 402b can be removed from a comestible press.

The cut conveyor belt 402b can be cleaned or otherwise processed while the cut conveyor belt 402b is removed from the apparatus to which it was attached. For instance, the cut conveyor belt 402b can be exposed to a food-grade cleaning process to remove the dough and other particles from the cut conveyor belt 402b.

In some examples, since the continuous conveyor belt 402a can get dirty on both sides, e.g., the top side that conveys comestibles and the bottom side that contacts the apparatus, all sides of the cut conveyor belt 402b can be cleaned. The top and bottom sides can be cleaned at least partially concurrently or separately.

Although FIGS. 4B-E depict two separate ends of the conveyor belt 402, those ends would actually be connected. For instance, with the cut 412 in the cut conveyor belt 402b, the other two ends of the cut conveyor belt 402b would actually be connected though this is not shown in the figures.

To rejoin the cut conveyor belt 402b into a rejoined continuous conveyor belt 402c, the comestible processing system can use a splice piece 414 to connect the two ends 406a-b of the conveyor belt, as shown in FIG. 4E. The comestible processing system can place the splice piece 414 between the two ends 406a-b such that the splice piece 414 is below a downstream processing end 406b and above an upstream processing end 406a given a comestible travel direction D.

The splice piece 414 includes two rows of apertures 416a-b. Each of the rows aligns with one of the second rows of apertures 410a-b in the conveyor belt 402. For instance, an upstream row of apertures 416a in the splice piece aligns with an upstream row of apertures in the conveyor belt 402. A downstream row of apertures 416b in the splice piece aligns with a downstream row of apertures 410b in the conveyor belt 402.

The comestible processing system can connect the splice piece 414 with the conveyor belt 402 to form the rejoined continuous conveyor belt 402c. For instance, the comestible processing system can use a process such as that described above for aligning the rows of apertures 408 and connecting the two ends of the conveyor belt 402 to form the continuous conveyor belt 402a to connect, e.g., separately, each of the ends 406a-b to respective portions of the splice piece 414. The comestible processing system can align the upstream rows of apertures 410a and 416a and connect an upstream end of the splice piece 414 with an upstream end 406a of the conveyor belt 402. The comestible processing system can align the downstream rows of apertures 410b and 416b and connect a downstream end of the splice piece 414 with a downstream end 406b of the conveyor belt 402.

The comestible processing system can secure a center portion of the splice piece 414 to the ends 406a-b of the conveyor belt 402. For instance, the comestible processing system can weld the center portion of the splice piece 414 to each of the ends 406a-b of the conveyor belt 402. This can substantially maintain a form of the splice piece 414 with respect to the conveyor belt 402, reduce a likelihood of the ends 406a-b moving away from each other, e.g., if the splice piece 414 were to go flat, or both.

The rejoined conveyor belt 402c has a thickness T where the two ends 406a-b are rejoined. For example, when the continuous conveyor belt 402a is initially formed, a connected portion of the continuous conveyor belt 402a can have a thickness T₁ that is substantially similar to an original thickness T₀ of the rest of the belt. The original thickness can be an average thickness, a target thickness, or both, to account for manufacturing tolerances. When adding the splice piece 414 to the cut conveyor belt 402b, the splice piece 414 increases a thickness of the rejoined conveyor belt 402c where the two ends 406a-b are rejoined. The thickness T of the rejoined ends can be approximately 50% greater than the thickness T₁, the thickness T₀, or both.

In some examples, the comestible processing system can remove a portion of the continuous conveyor belt 402a within a threshold distance of the two ends 406a-b that has a thickness that does not satisfy a threshold thickness. The threshold thickness can be a target thickness, e.g., T₁. This can include removing a portion of the conveyor belt 402 within a threshold distance of the row of apertures 408, e.g., that is depicted as thicker than other portions of the conveyor belt 402, although the drawings are not necessarily to scale. By forming a cut conveyor belt 402b by removing the portion that has a thickness that does not satisfy the threshold thickness, the comestible processing system can reduce a variance in the thickness of the rejoined conveyor belt 402c which can increase comestible processing uniformity.

In some implementations, a width of the cut 412 can be approximately the same size as a thickness of the splice piece 414. This can increase a likelihood that the continuous conveyor belt 402a and the rejoined continuous conveyor belt 402c are approximately the same length. By having the same length, the conveyor belts 402a, 402c can be more likely to have the same tension on the apparatus in the comestible processing system. This can increase a likelihood of uniform comestible processing before and after the conveyor belt 402 rejoining process.

The splice piece 414 can be manufactured from the same type of material as the conveyor belt 402. For instance, the splice piece can be manufactured from silicon, fiberglass, Teflon, or a combination of these.

In some implementations, the comestible processing system can reduce a thickness of an originally joined portion of the conveyor belt 402 as part of the rejoining process. For example, first portions of the conveyor belt 402 around the first rows of apertures 408a-b can be thinner than the inner portions of the conveyor belt 402. A thickness of the first portions can be selected such that, when connected, the connected first portions have approximately the same thickness as a thickness of the inner portions of the conveyor belt 402.

Since the comestible processing system is adding the splice piece 414 onto the two end 406a-b of the conveyor belt 402, this rejoined portion of the conveyor belt 402 would be thicker than the inner portions of the conveyor belt 402. To reduce, eliminate, or both, the variation in the thicknesses, the comestible processing system can reduce a thickness of the first portions, e.g., by melting at least some of the first portions, other portions of the two ends 406a-b, or a combination of both.

In some implementations, the upstream portion of the splice piece 414 is above the conveyor belt 402 while the downstream portion of the splice piece 414 is below the conveyor belt 402 to reduce friction, to reduce a likelihood that the conveyor belt 402 will stick to other components in the comestible processing system, or a combination of both.

The configuration of the connection of the splice piece 414 and the conveyor belt 402 can be any appropriate configuration. For instance, the downstream portion of the splice piece 414 can be above the downstream portion of the conveyor belt 402 while the upstream portion of the splice piece 414 can be below the upstream portion of the conveyor belt 402. This can cause the downstream portion to be slightly above the upstream portion, reducing a likelihood that the rejoined portion of the rejoined conveyor belt 402 will stick to other components in the comestible processing system. In some examples, the splice piece 414 can be entirely above or entirely below the conveyor belt 402.

In some implementations, the conveyor belt 402 does not support comestibles at positions above the rows of apertures 408a-b, 410a-b. For instance, when processing comestibles on a potentially non-uniform surface of the conveyor belt 402 might result in different properties for the comestibles, the conveyor belt 402 might not support comestibles at positions above the rows of apertures 408a-b, 410a-b. This can occur when the conveyor belt 402 is included in a comestible press, e.g., as compared to an oven or a cooler.

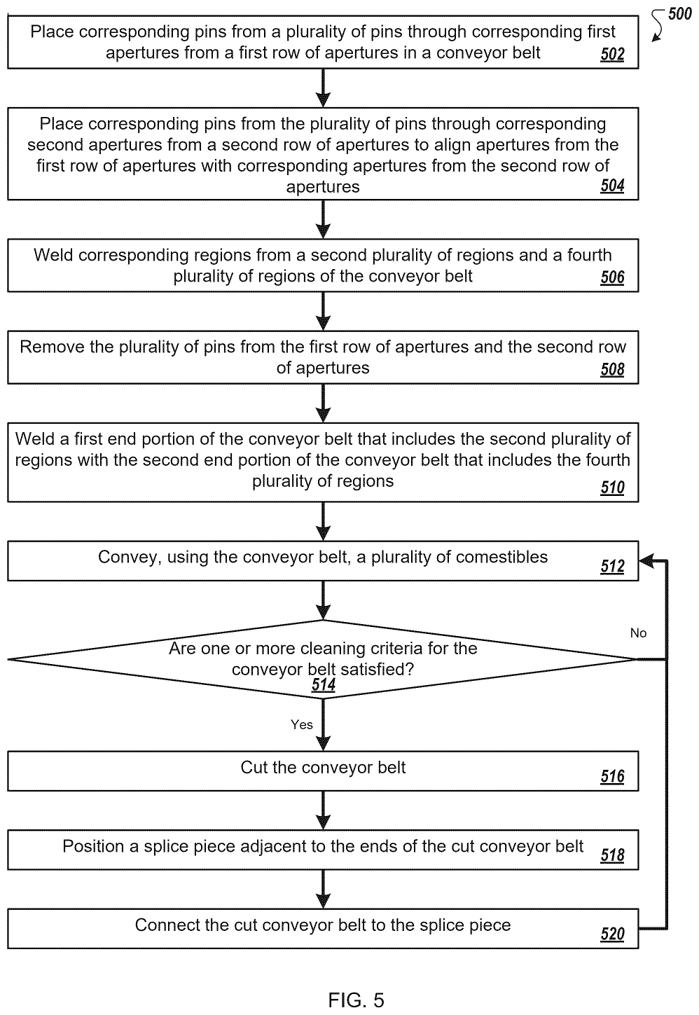

FIG. 5 is a flow diagram of an example process 500 for forming a continuous conveyor belt, e.g., the conveyor belt 102, 202, or 302. For example, the process 500 can be used by a comestible processing system, e.g., the forming tool 304 from the environment 300, a comestible press, another apparatus in the comestible processing system, or a combination of two or more of these.

A forming tool places corresponding pins from a plurality of pins through corresponding first apertures from a first row of apertures in a conveyor belt (502). For example, the forming tool can move a guide that includes the pins from a retracted position to an extended position, placing the pins through the first apertures. The forming tool can perform this operation while the conveyor belt is positioned on a component in a comestible processing system, e.g., a comestible press.

The conveyor belt has a first end portion and a second end portion. The end portions can be latitudinal end portions. The first end portion can include a) the first row of apertures, b) a first plurality of regions that each surround a corresponding aperture from the first row of apertures, and c) a second plurality of regions between sequential regions from the first plurality of regions. The second end portion can include a) the second row of apertures, b) a third plurality of regions that each surround a corresponding aperture from the second row of apertures, and c) a fourth plurality of regions between sequential regions from the third plurality of regions.

The forming tool places corresponding pins from the plurality of pins through corresponding second apertures from a second row of apertures to align apertures from the first row of apertures with corresponding apertures from the second row of apertures (504). For instance, the forming tool can move the guide that includes the pins from the retracted position to the extended position, placing the pins through the second apertures. In some examples, when moving the guide from the retraced to the extended position, the forming tool can place the pins through the first apertures and the second apertures, e.g., as part of the same movement.

The forming tool can place a securing bracket onto the ends of the conveyor belt after placing the pins through the corresponding apertures. By placing the securing bracket onto the ends of the conveyor belt, the forming tool can define the regions using the securing bracket.

The forming tool welds corresponding regions from a second plurality of regions and a fourth plurality of regions of the conveyor belt (506). The forming tool can weld the second and fourth regions using any appropriate temperature and pressure. The temperature can be between 400 to 1000° F. , preferably between 500 to 780° F. , preferably between 750 to 780° F.

The forming tool can apply the temperature to the second plurality of regions and the fourth plurality of regions for any appropriate processing time. For instance, the forming tool can apply the temperature for between five to 40 seconds, preferably between five to ten seconds.

The forming tool can apply at least three pounds of pressure per square inch to the conveyor belt. For instance, the forming tool can apply between three and 50 pounds of pressure per square inch to the conveyor belt, preferably between three and 30 pounds of pressure per square inch or eight pounds of pressure per square inch.

For forming tool can use one or more irons to weld the corresponding regions. For instance, the forming tool can place one or more welding tools above the corresponding regions, contact the irons with one of the regions from a pair of corresponding regions, and weld the pair of corresponding regions together. The forming tool can use a single iron that is moved from one region to another to weld the corresponding second and fourth regions. The forming tool can use multiple irons, e.g., two or more irons. In some examples, the forming tool can use one iron per pair of second and fourth regions.

The forming tool removes the plurality of pins from the first row of apertures and the second row of apertures (508). For instance, the forming tool can remove the securing bracket from on top of the rows of apertures. The forming tool can retract the guide that includes the pins to remove the pins from the apertures.

The forming tool can position a welding platform behind the end portions of the conveyor belt. For example, after removing the pins from the apertures, the forming tool can place the welding platform behind the ends of the conveyor belt, which ends include the first, second, third, and fourth regions.

The welding platform can have a substantially flat surface. The substantially flat surface can reduce a likelihood that the ends of the conveyor belt will have wrinkles after the welding process.

The forming tool welds a first end portion of the conveyor belt that includes the second plurality of regions with the second end portion of the conveyor belt that includes the fourth plurality of regions (510). For instance, the forming tool can maintain the alignment of the first row of apertures and the second row of apertures with a forming tool while welding the first end portion of the conveyor belt with the second end portion of the conveyor belt. The forming tool can maintain the alignment by holding the conveyor belt in place given the initial welding of the corresponding regions from the second and fourth regions.

The forming tool can weld the first end portion and the second end portion using any appropriate temperature and pressure. The temperature can be between 400 to 1000° F. , preferably between 500 to 780° F. , preferably between 760 to 780° F. The temperature can be the same or a different temperature as the temperature used in operation 506.

The forming tool can weld the first end portion and the second end portion by welding any appropriate corresponding regions. For instance, the forming tool can weld corresponding regions from the first regions and the third regions. The forming tool can weld corresponding regions from the first regions and the third regions and also weld corresponding regions from the second regions and the fourth regions.

The forming tool can weld the first end portion and the second end portion by placing one or more irons on the first end portion and the second end portion, e.g., on an area that includes the overlap between the first end portion and the second end portion. The forming tool can position the iron toward a center of the area and move the iron toward a longitudinal edge of the area to weld the two end portions. After reaching the longitudinal edge, the forming tool can position the iron toward the center of the area and move the iron toward the other longitudinal edge. In some examples, when the forming tool uses two irons, the forming tool can position a first iron toward the center of the area, begin moving the first iron toward the longitudinal edge, position a second iron toward the center of the area, and then begin moving the second iron toward the other longitudinal edge. By moving an iron from the center of the area toward the longitudinal edges, the forming tool can reduce a likelihood of wrinkles forming in the area of the conveyor belt.

A time used to weld the two ends together can be selected using a width of the belt, thicknesses of the two ends, a material used to manufacture the two ends, or a combination of these. For instance, the time used to weld the two ends together can be between 1 to 30 minutes, preferably between 2 to 10 minutes.

The forming tool can apply at least three pounds of pressure per square inch to the conveyor belt. For instance, the forming tool can apply between three and 50 pounds of pressure per square inch to the conveyor belt, preferably between three and 30 pounds of pressure per square inch or eight pounds of pressure per square inch. The pressure used in operation 510 can be the same as or different than the pressure used during operation 506.

A system conveys, using the conveyor belt, a plurality of comestibles (512). For example, when the forming tool welds the ends of the conveyor belt while the conveyor belt is in a component of the system, e.g., in a comestible press, the system can use the conveyor belt to convey comestibles through the component, e.g., through the comestible press.

In some implementations, the comestible processing system can determine whether to remove the conveyor belt from the component, e.g., the comestible press. For instance, the comestible processing system can determine whether one or more cleaning criteria for the conveyor belt are satisfied (514). The one or more cleaning criteria can indicate an amount of food particles on the conveyor belt or other appropriate criteria for when the conveyor belt should be cleaned. One or more computers included in the comestible processing system can determine whether the one or more cleaning criteria are satisfied, e.g., using data from a camera that captures images of the conveyor belt. The images can be of an upper surface of the conveyor belt, a lower surface of the conveyor belt, or a combination of both.

In some examples, the comestible processing system can determine whether the conveyor belt has reached an end of life and cannot be cleaned. For instance, although only the first row of apertures was used to connect the two ends of the conveyor belt, and the conveyor belt was not rejoined, the comestible processing system can determine whether the conveyor belt should be removed from the component and no longer used, e.g., discarded.

In response to determining that none of the one or more cleaning criteria are satisfied, the comestible processing system can continue to use the conveyor belt to transport comestibles. For instance, the process 500 can proceed to operation 512.

The comestible processing system cuts the conveyor belt (516). The comestible processing system can cut the conveyor belt in response to determining that at least one of the one or more cleaning criteria are satisfied. The comestible processing system can use any appropriate process to cut the conveyor belt. For example, the comestible processing system can use a blade to cut the conveyor belt in a direction traverse to the direction in which comestibles are transported by the conveyor belt.

The comestible processing system can remove the conveyor belt from the component to which the conveyor belt was previously attached. The comestible processing system, or another system, can clean the conveyor belt. When the one or more cleaning criteria are no longer satisfied, e.g., when the conveyor belt is clean, the comestible processing system can position the cut conveyor belt onto a component in the comestible processing system. The component can be the same component from which the cut conveyor belt was removed, e.g., the comestible press, or another component.

The comestible processing system positions a splice piece adjacent to the ends of the cut conveyor belt (518). For instance, the comestible processing system can position one portion of the splice piece above an end of the cut conveyor belt and another portion of the splice piece below another end of the cut conveyor belt. This can increase a likelihood that the rejoined continuous conveyor belt has approximately the same length as the original continuous conveyor belt, e.g., when material is removed from the continuous conveyor belt during the cutting process. The comestible processing system can position the splice piece above both ends of the conveyor belt, e.g., outside the conveyor belt when the belt forms a continuous piece. The comestible processing system can position the splice piece below both ends of the conveyor belt, e.g., inside the conveyor belt when the belt forms a continuous piece. Positioning entirely above or below the belt can be advantageous when no material is removed from the continuous conveyor belt during the cutting process, e.g., so that the length of the rejoined continuous conveyor belt is approximately the same as the length of the original continuous conveyor belt.

The comestible processing system, e.g., the forming tool, connects the cut conveyor belt to the splice piece (520). For instance, the forming tool can perform one or more of operations 502 through 510 to connect the downstream end of the conveyor belt to the downstream end of the splice piece, to connect the upstream end of the conveyor belt to the upstream end of the splice piece, or a combination of both. The connecting process can occur on the component, e.g., comestible press.

After connecting the ends of the cut conveyor belt, the comestible processing system can use the rejoined conveyor belt to convey additional comestibles. For instance, the process 500 can proceed to operation 512.

In some implementations, after rejoining the end of the conveyor belt, when the comestible processing system determines that the one or more cleaning criteria are satisfied, the comestible processing system can determine to discard the rejoined conveyor belt. Since the conveyor belt was already rejoined once using the second rows of apertures, the comestible processing system can determine that when the conveyor belt should be cleaned, the conveyor belt reached its end of life.

In some implementations, the process 500 can include additional operations, fewer operations, or some of the operations can be divided into multiple operations. For example, the forming tool can align the first apertures and the second apertures as a single operation instead of performing operations 502 and 504. In some examples, the process 500 does not include conveying the plurality of comestibles. For instance, the process 500 can include aligning the first apertures and the second apertures, welding corresponding regions from the second and fourth pluralities of regions, and welding the first and second end portions without the other operations in the process 500.

The order of operations in the process 500 described above is illustrative only, and the forming of the continuous conveyor belt can be performed in different orders. For example, the process 500 need not remove the pins from the apertures before operation 510, e.g., when the forming tool performs both welding processes using the guide as the welding support.

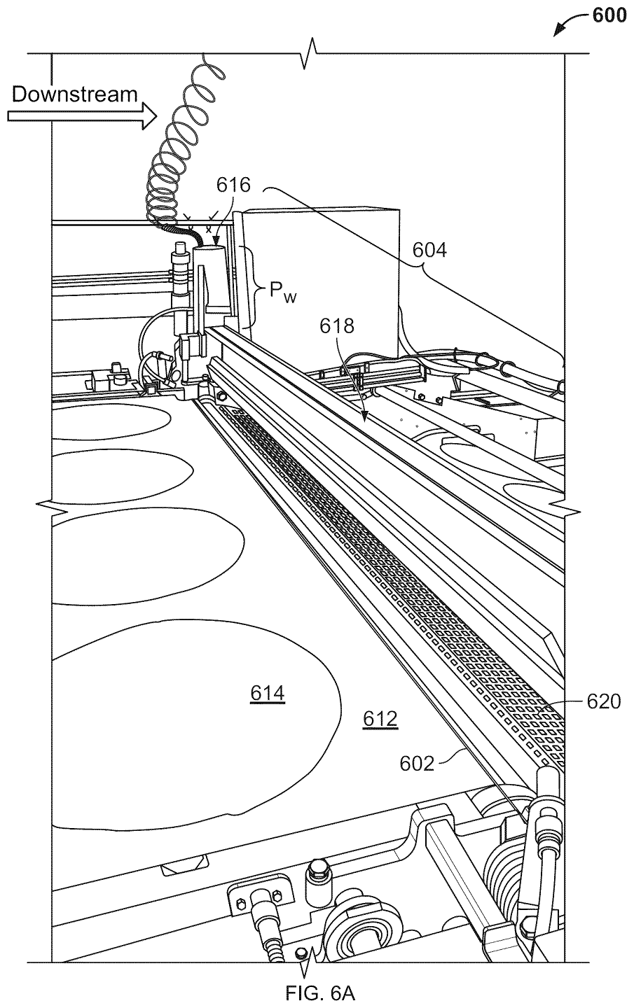

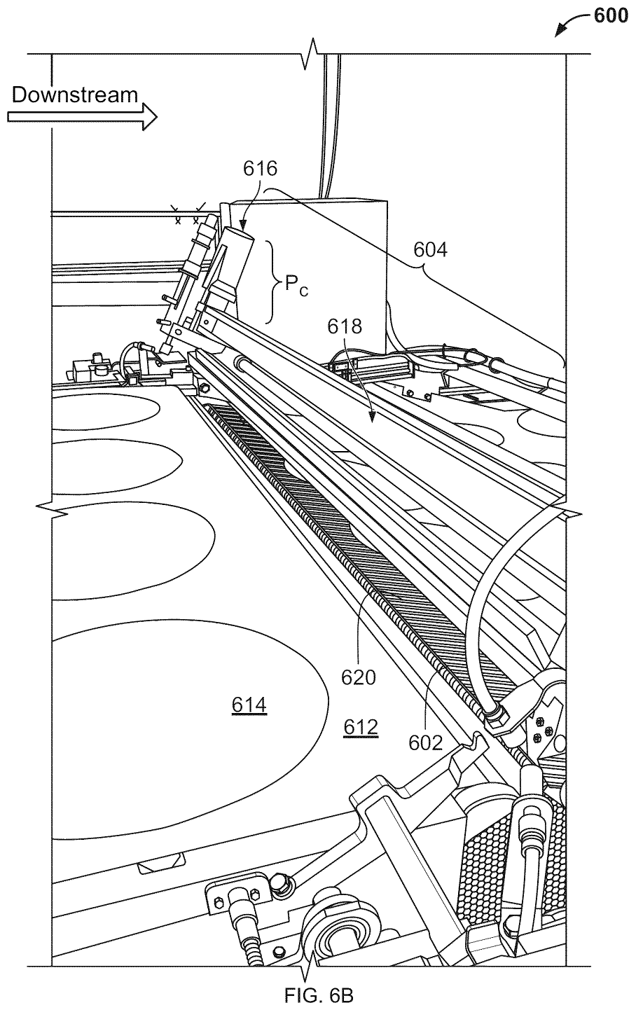

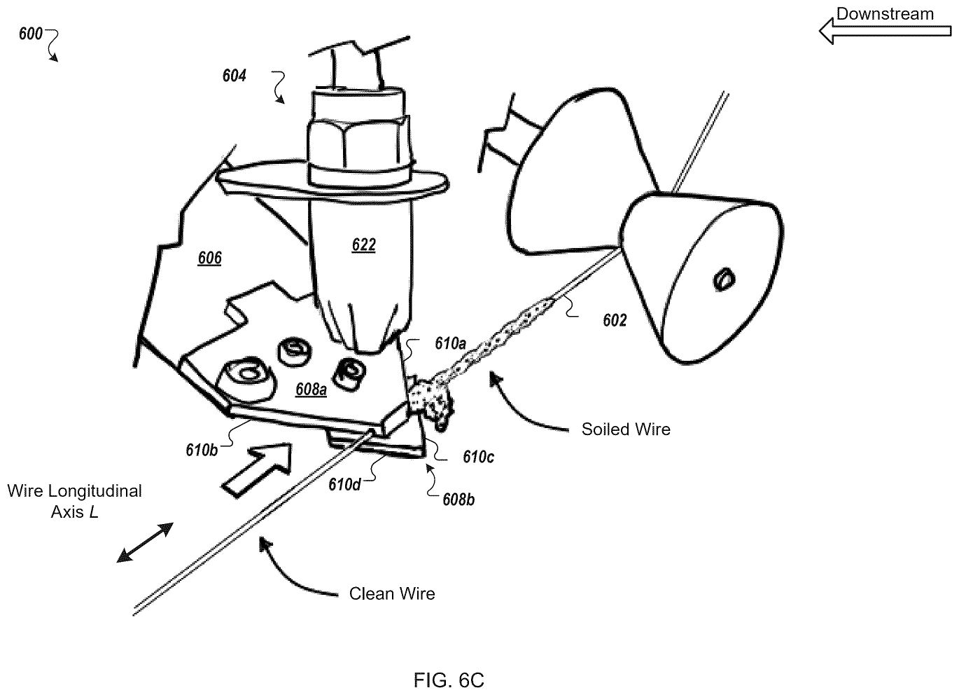

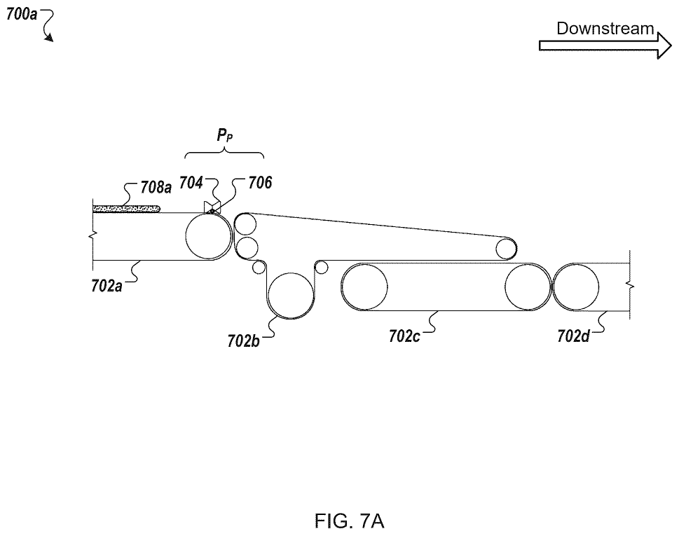

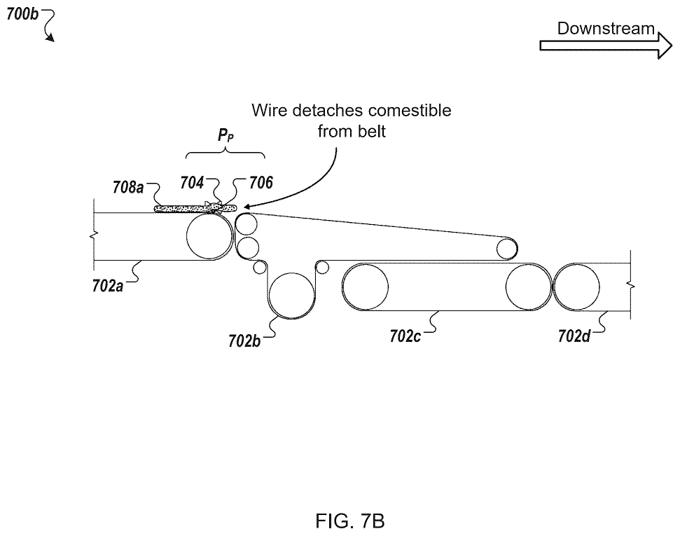

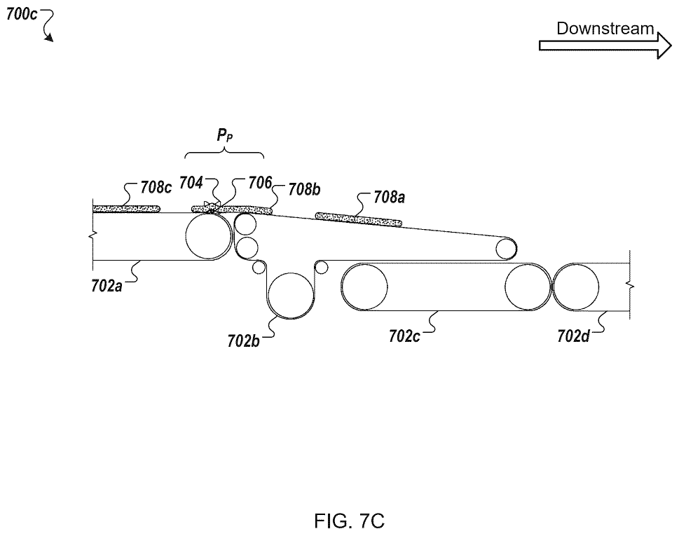

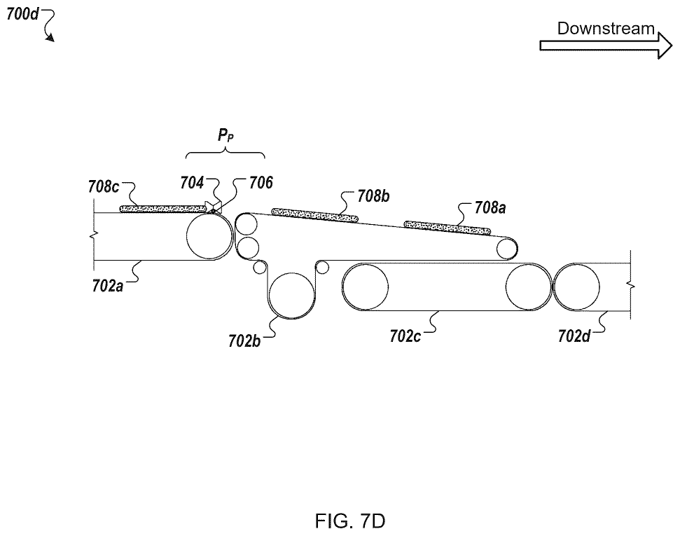

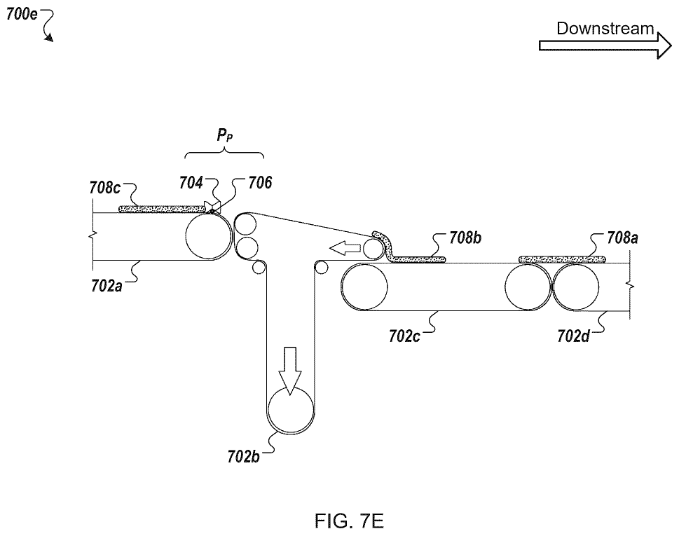

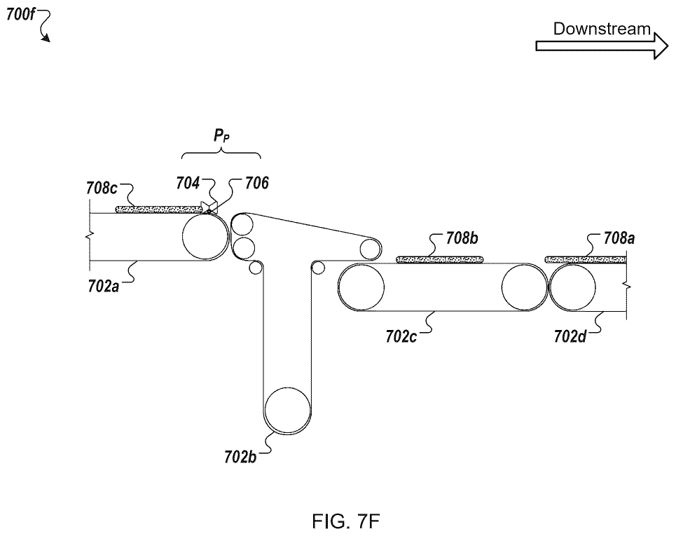

FIGS. 6A-C depict an example of a portion of a comestible processing system 600.

FIG. 6A depicts an example of a portion of a comestible processing system 600. As depicted, comestible processing system 600 includes a conveyor belt 612 configured to transport comestibles 614 along the longitudinal axis of the conveyor belt 612. The comestible processing system 600 includes a discharge wire 602, e.g., the wire 204.

The comestible processing system 600 includes a wire cleaning apparatus 604. The wire cleaning apparatus 604 includes a wire cleaning head 616 that is configured to translate laterally across a track 618. The wire cleaning head 616 can include a shuttle or another device that translates the wire cleaning head 616 laterally across the track 618, e.g., and at least a portion of the length of the discharge wire 602, e.g., the portion of the discharge wire that comes into contact with comestibles during operation of the comestible processing system 600.

The wire cleaning head 616 can be retained in a first, waiting position P_{w} with respect to the conveyor belt 612, e.g., while the wire cleaning head 616 is not engaged in a cleaning process. For example, the wire cleaning head 616 of the wire cleaning apparatus 604 is depicted in FIG. 6A as retained in a first, waiting position P_{w}. In some implementations, the wire cleaning apparatus 604 includes two waiting positions for the wire cleaning head with respect to the conveyor belt 612, e.g., located laterally on either side of the conveyor belt 612. A waiting position P_{w} can be a position for the wire cleaning apparatus when the comestible processing system 600 processes comestibles 614, e.g., as the comestible processing system 600 moves comestibles 614 laterally downstream along a longitudinal axis of a conveyor belt, as shown in FIG. 6A.

By using the wire 602, the comestible processing system 600 need not include a roller 212, shown in FIG. 2. For instance, the wire 602 can transfer comestibles 614 from the first conveyor belt 612 to the second conveyor belt 620 with a reduced likelihood of damage, increased likelihood of transfer, or both, compared to other systems, e.g., that use a roller.

While the wire cleaning apparatus 604 is in the waiting position P_{w}, the wire can be in a processing position Pₚ, shown in FIGS. 7A-G. FIGS. 7A-J show portions of a comestible processing system 700a-j, e.g., the comestible processing system 600. The comestible processing system 700 can include one or more conveyor belts 702a-d. For instance, the first conveyor belt 612 can be the conveyor belt 702a and the second conveyor belt 620 can be the conveyor belt 702b. In some examples, the comestible processing system 700 might include two conveyor belts, e.g., 702a-b, or might include three conveyor belts, e.g., 702a-b and 702d.

The comestible processing system 700 includes a fastener 704 and a wire 706, e.g., the discharge wire 602. The fastener 704 can be any appropriate type of fastener that couples the wire 706 to a support frame in the comestible processing system 700. For instance, the fastener 704 can be a spool. Although FIGS. 7A-J show the spool in a horizontal position, some implementations can include the spool in a vertical position, multiple spools, e.g., in different positions, or any combination of both. For instance, a first spool that couples to a first end of the wire 706 can be in a horizontal position and a second spool that couples to the first end of the wire 706 can be in a vertical position. The opposite, second end of the wire can couple to one or more second fasteners (not shown). The second fasteners can be any appropriate type of fasteners, e.g., one or more fasteners such as another first spool, another second spool, or both. The comestibles 708 do not contact the fastener 704, e.g., the fastener is on one side or the other of the conveyor belt 702a.

The comestible processing system 600 includes an arm 606, depicted in FIG. 6C. Arm 606 can couple to one or more rails or other translation mechanisms 618. Arm 606 can be configured to translate the wire cleaning head laterally across at least a portion of the length of the discharge wire 602, e.g., the portion of the discharge wire that comes into contact with comestibles during operation of the comestible processing system 600. The arm 606 can be configured to translate along the one or more translation mechanisms by a servo motor coupled to one or more controllers.

In some implementations, the wire cleaning apparatus 604 and discharge wire 602 are translatable between a first orientation with respect to the conveyor belt and a second orientation with respect to the conveyor belt. The first orientation can be when the comestible processing system 600 is operating without any detected obstructions, e.g., as shown in FIGS. 7A-F. Under normal conditions, comestibles can be being processed along the conveyor belt and the discharge wire 602 is oriented with respect to the conveyor belt to detach the comestibles from the conveyor belt, e.g., as shown in FIG. 7B-C. This first orientation can include the wire cleaning head 616 located in any of the waiting positions P_{W}, shown in FIG. 6A, and the wire 602, 706 in the processing position Pₚ, shown in FIGS. 7A-F.

The second orientation can be when the comestible processing system 600 is operating under a wire cleaning condition or de-jam conditions, e.g., the discharge wire is being cleaned or a comestible is being de-jammed from the conveyor belt, gap, discharge wire or another downstream location. When in the second orientation, the wire cleaning head 616 can be in a cleaning position P_{c}, shown in FIG. 6B. When in the second orientation, the wire 602, 706 can be in the cleaning position P_{d/c}, shown in FIGS. 7I-J. In the first orientation shown in FIG. 6A, the wire cleaning apparatus 604 and discharge wire 602 are oriented over the conveyor belt, e.g., the discharge wire is oriented as described with reference to FIG. 2. In the first orientation, the wire cleaning apparatus 604 can be located at waiting position P_{w}, e.g., located laterally on either side of the conveyor belt.

In the second orientation, the wire cleaning apparatus 604 and discharge wire 602 can be offset above the conveyor belt as shown in FIGS. 6B and 7I-J, e.g., displaced along a parallel direction to the movement of the conveyor belt, such that the discharge wire 602 is located in position P_{d/c} over a gap between the conveyor belt 612 and a second, downstream conveyor belt 620, e.g., the conveyor belts 702a-b, or another transfer apparatus. Displacing the wire cleaning apparatus 604 and discharge wire 602 as described can reduce a likelihood of debris removed from the discharge wire 602 from landing on the conveyor belt 612, the second, downstream conveyor belt 620, or both. In some instances, the wire cleaning apparatus 604 and discharge wire 602 are displaced vertically with respect to the surface of the conveyor belt 612. Displacing the wire cleaning apparatus 604 and the discharge wire 602 vertically can increase a likelihood of movement without obstruction of the wire cleaning apparatus 604 as the wire cleaning apparatus 604 translates across the length of a portion of the wire 602, reduce a likelihood of contact of the wire cleaning apparatus 604 with the conveyor belt 612, or both.

For instance, referring to FIGS. 7A-F, the comestible processing system 700 can process one or more comestibles 708a-c while the wire 706 is in the processing position Pₚ. As shown in FIGS. 7A-B, the conveyor belt 702a moves the comestible 708a toward the wire 706. The wire 706 detaches the comestible 708a from the conveyor belt 702a, causing the comestible to transfer onto the conveyor belt 702b. Although the comestible 708a might be able to be transferred between the conveyor belts 702a-b without the wire 706, the comestible might be damaged in the process. As a result, the use of the wire 706 can reduce a likelihood of damage to the comestible 708a.

In FIG. 7C, multiple comestibles are in the comestible processing system 700c. For instance, the comestible processing system 700c is supporting the first comestible 708a on the second conveyor belt 702b, transferring a second comestible 708b from the first conveyor belt 702a to the second conveyor belt 702b using the wire 706, and a moving a third comestible 708c toward the wire 706 using the first conveyor belt 702a. FIGS. 7D-E show further movement by the comestible processing system 700d-e of the comestibles 708a-c.

The comestible processing system 700 can process comestibles according to pressing patterns. In these implementations, the comestible processing system 700 can pause movement of comestibles by the first conveyor 702a, e.g., while a press upstream of the wire 706 presses comestibles on the first conveyor belt 702a. To keep other comestibles moving, the second conveyor belt 702b can change shape, as shown in FIGS. 7E and 7F. The last conveyor belt 702d can transfer the comestibles into an oven.

FIG. 7G depicts an example of a malformed comestible 708d, e.g., as one type of obstruction. The malformed comestible 708d can be the result of a comestible that was not pressed, was not sufficiently pressed, or some other cause. The pressing process can be performed by a process, as described elsewhere. Examples of obstructions can include malformed comestibles 708d, comestibles that get stuck on the wire 706, comestibles that get stuck together, or any combination of these. The comestible processing system 700 can detect the malformed comestible 708d, e.g., using one or more sensors. The comestible processing system 700g-h can detect the malformed comestible 708d before the comestible 708d, contacts the wire 706, while the comestible 708d contacts the wire 706, or some combination of both.

When the comestible processing system 700 detects an obstruction, such as the malformed comestible 708d, the comestible processing system 700 moves the wire 706, and optionally the fastener 704, to the discharge position P_{d/c}. While in the discharge position P_{d/c}, the wire 706 is horizontally above the conveyor belts 702a-b, though not necessarily directly above the conveyor belts 702a-b. This position enables movement of comestibles 708d along the conveyor belts 702a-b without the comestibles 708d getting stuck on the wire 706. For instance, when the comestible 708d is detected as an obstruction at the wire 706, as shown in FIG. 7H, the obstruction can cause other comestibles to hit it and create a larger obstruction. By moving the wire 706 to the discharge position P_{d/c}, the comestible processing system 700 can move the obstruction downstream, e.g., to remove the obstruction from the conveyor belts 702a-c. This movement of the wire 706 can dislodge any obstructions that are on the wire 706. In some examples, the comestible processing system 700 can move the wire cleaning apparatus 604 across the wire 706 to remove any obstructions stuck on the wire 706.

Returning to FIG. 6C, the arm 606 couples to one or more cleaning blades 608a-b. In some examples, the arm 606 can be part of, e.g., manufactured as a unitary part, one of the blades, e.g., a second cleaning blade 608b.

The wire cleaning head of the wire cleaning apparatus 604 includes multiple cleaning edges 610a-d. For instance, at least some, e.g., each, of the cleaning blades 608a-b can include three or more edges including two of the cleaning edges. A first cleaning blade 608a can include a first cleaning edge 610a and a second cleaning edge 610b. A second cleaning blade 608b can include a third cleaning edge 610c and a fourth cleaning edge 610d.

The cleaning edges 610a-d are adapted to remove debris from the discharge wire. For example, as the comestible processing system 600 uses the discharge wire 602 to remove comestibles from a comestible conveyor belt, e.g., and transfers the comestibles to a second, downstream conveyor belt, debris from the comestibles and potentially other sources can build up on the discharge wire 602, e.g., forming a soiling on the wire. The comestible processing system 600 can use one or more of the cleaning edges 610a-d to remove at least a portion, e.g., all, of the debris from the discharge wire 602, e.g., as part of a wire cleaning process. For instance, during a first cleaning operation, the comestible processing system 600 can use the first cleaning edge 610a and the third cleaning edge 610c to remove debris, if any, from the discharge wire 602, as shown in FIG. 6C. During a second, subsequent cleaning operation, the comestible processing system 600 can use the second cleaning edge 610b and the fourth cleaning edge 610d to remove debris, if any, from the discharge wire 602, e.g., moving in an opposite direction of what is shown in FIG. 6C. Although some examples might refer to debris removal, the cleaning operation might not necessarily remove any debris, e.g., if there is not sufficient debris buildup on the discharge wire 602.

In some implementations, as depicted in FIG. 6C, the wire cleaning apparatus 604 includes a blower 622. The blower 622 can be arranged with respect to the cleaning edges of the wire cleaning head and oriented to blow debris removed from the discharge wire 602. In some instances, the blower 622 is oriented such that a flow of air or other gas from the blower 622 moves the debris removed from the discharge wire 602 away from landing on the conveyor belt 612. For example, the blower 622 can be oriented such that the flow from the blower moves debris removed from the discharge wire 602 into a gap between the conveyor belt 622 and a second, downstream conveyor belt 620, e.g., into a waste region. The blower 622 can be fluidically connected to a compressed air or other gas source, e.g., clean dry air or nitrogen, and can include one or more flow and/or pressure regulators (not shown) which can be used to adjust a flow of the air or gas through the blower.

During processing of comestibles, the wire cleaning apparatus of the comestible processing system 600 can clean the discharge wire 602 using the cleaning edges 610a-d of the wire cleaning head. The comestible processing system 600 can initiate a cleaning process on the discharge wire 602 according to a schedule, e.g., every twenty pressing cycles. Pressing patterns layouts and pressing cycles are described in more detail below. In some examples, the comestible processing system 600 can clean the discharge wire 602 periodically, e.g., upon detection of debris on the discharge wire 602, a jam of comestibles within a threshold distance of the discharge wire 602, or both. A jam of comestibles within the threshold distance of the discharge wire 602 can include one or more comestibles that are touching the discharge wire 602, that are positioned in a gap between adjacent conveyor belts, or both. The discharge wire 602 can be adapted to transfer comestibles across the gap between adjacent conveyor belts. However, comestibles might still get stuck on an upstream conveyor belt of the adjacent conveyor belts, get stuck in the gap, or both. The comestible processing system 600 can clean the discharge wire 602 upon detecting a jam, perform a comestible removal process, or both. Further details of the comestible removal process are described with reference to FIGS. 7G-J and 8A-7B.

The comestible processing system 600 can detect debris on the discharge wire 602 using any appropriate process, hardware, or both. For instance, the comestible processing system 600 can include a sensor (not shown). The sensor can be any appropriate type of sensor, such as a laser photo eye or a camera. When the sensor detects debris on the discharge wire, within a threshold distance of the discharge wire, or either, the sensor can send a signal to the comestible processing system 600, e.g., to a controller included in the comestible processing system 600.

The comestible processing system 600 receives the signal. The comestible processing system 600, in response to receipt of the signal, can send a command to the wire cleaning apparatus 604. The command can cause the wire cleaning apparatus 604 to perform a cleaning operation on the discharge wire 602, e.g., while the wire 706 is in the discharge position P_{d/c} shown in FIGS. 7I-J. The cleaning operation can include any appropriate number of passes by the wire cleaning head of the cleaning apparatus 604 across the discharge wire 602. For instance, the cleaning operation can include one pass of the wire cleaning head of the wire cleaning apparatus 604 across the discharge wire along the longitudinal axis L of the wire 602, shown in FIG. 6C. In such cases, the wire cleaning apparatus 604 can translate the wire cleaning head, and optionally the blower 622, from a first waiting location to a second waiting location located laterally on either side of the conveyor belt 612 in a first cleaning process. The wire cleaning apparatus 604 can translate the wire cleaning head from the second waiting location to the first waiting location during a second cleaning process, subsequent to the first cleaning process.

In some examples, the comestible processing system 600 can determine a number of passes that the wire cleaning apparatus 604 should perform. For instance, the comestible processing system 600 can determine a predicted amount of debris on the discharge wire 602. The comestible processing system 600 can use the predicted amount of debris to determine the number of passes. In some instances, the comestible processing system 600 can determine, after a pass across the discharge wire 602 by the wire cleaning apparatus 604, whether the discharge wire 602 satisfies a cleaning criterion. If so, the comestible processing system 600 can determine to skip sending a command for another pass across the discharge wire 602. If not, the comestible processing system 600 can send a command to the wire cleaning apparatus 604, or an actuator that moves the wire cleaning head of the wire cleaning apparatus 604, that causes the wire cleaning head to pass across the discharge wire 602 again.

Examples that refer to a pass across the discharge wire 602 can refer to a pass along any appropriate length of the discharge wire 602, e.g., and need not include movement of the wire cleaning head 616, and optionally the blower 622, of the wire cleaning apparatus 604 across the entirety of the discharge wire 602. This can occur because the wire cleaning apparatus 604 might be physically prevented from moving the wire cleaning head 616 across all portions of the discharge wire 602, e.g., the portions of the discharge wire 602 that couple to a housing of the comestible processing system 600. For example, this can occur when the wire cleaning head of the wire cleaning apparatus 604 contacts an obstruction that prevents the wire cleaning apparatus 604 from making a complete pass across the discharge wire 602. As a result, a pass need not be a full pass.

The cleaning edges 610a-d of the wire cleaning head 616 can be manufactured using any appropriate process. The cleaning edges 610a-d can be assembled using any appropriate process. The manufacturing, assembly, or both, of the cleaning edges can enable the cleaning edges to remove debris from the discharge wire 602. Some or all of the cleaning edges 610a-d can be manufactured, assembled, or both, using different processes. For instance, when the first and second cleaning edges 610a-b are part of a unitary piece, e.g., the first cleaning blade 608a, the first and second cleaning edges 610a-b can be manufactured using a different process than, and assembled using a different process than, the third and fourth cleaning edges 610c-d. The third and fourth cleaning edges 610c-d can be part of a unitary piece, e.g., the second cleaning blade 608b, assembled as part of the same process, or both.

The components of the wire cleaning apparatus can be manufactured from any appropriate material. For instance, the cleaning blades 608a-b can be manufactured from metal, e.g., steel, or plastic. The cleaning edges 610a-d can be manufactured from metal, e.g., steel, or plastic. The cleaning blades 608a-b, the cleaning edges 610a-d, or both, can have any appropriate strength. The cleaning edges 610a-d can have any appropriate angle, sharpness, or both, e.g., that enables the respective cleaning edge 610 to remove debris from the discharge wire.

The cleaning edges 610a-d can be at an angle with respect to the discharge wire 602. For instance, the discharge wire 602 can include a longitudinal axis L. The longitudinal axis L can be approximately perpendicular to a longitudinal axis of the conveyor belt. The cleaning edges 610a-d can each be at an angle to the longitudinal axis L. The angles can be the same or different for at least some of the cleaning edges 610a-d. The angles can be between zero and ninety degrees, inclusive or exclusive. For example, the angles can be between five and eighty-five degrees, inclusive or exclusive.

The cleaning blades 608a-b can form an aperture through which the discharge wire 602 is located. The size of the aperture can be any appropriate size, as described in more detail below. For instance, the size of the aperture can be selected given the size of the discharge wire 602. The aperture can be sized so that the cleaning blades 608a-b can pass across the discharge wire 602, removing debris from the discharge wire 602, while reducing a likelihood that the cleaning blades 608a-b damage the discharge wire 602.

In some implementations, the wire cleaning apparatus 604 includes a single cleaning blade 608. For instance, the wire cleaning apparatus 604 might include only the first cleaning blade 608a.

FIGS. 8A-C depict example cleaning blades 800a-b. The cleaning blades can be the cleaning blades 608a-b of FIG. 6C.

The cleaning blades 800a-b can have any appropriate shape. The cleaning blade 800a-b can have complementary shapes, the same shapes, or non-complimentary shapes. Complementary shapes can be shapes that are not exactly the same size, type, or both, but have one or more sides that align. Non-complementary shapes might not have any sides that align, e.g., the respective edges of the cleaning blades 800a-b are adjacent to surfaces of the other blade that are not substantially parallel to the respective edge. These edges might all be on one of the cleaning blades, when that blade is smaller than the other. In some instances, some edges of different ones of the cleaning blades 800a-b are adjacent to surfaces of the other such that a first edge of a first cleaning blade is adjacent to a first surface of a second cleaning blade, and a second edge of the second leaning blade is adjacent to a second surface of the first cleaning blade.

The cleaning blade 800b can have any appropriate dimensions L₁ and W₂. The dimensions can be selected given the length of the cleaning wire, a duration of a cleaning process, tolerances for a cleaning process, or any combination of these. In some instances, the dimensions can be approximately equal. In some examples, the length L₁ can be greater than the width W₂. For example, the length can be between 1 and 5 includes, e.g., 2 inches. The width can be between 0.5 and 4 includes, e.g., 1.72 inches.

The cleaning blades 800a-b can couple to each other. In some examples, the cleaning blades 800a-b can be removably secured or permanently secured. For instance, the cleaning blades 800a-b can be attached to each other using screws, bolts, solder, latches, another appropriate process, or any combination of these. When using multiple coupling components, some of these components can be a distance L₂ apart, e.g., all of these components. In some examples, the cleaning blades 800a-b can be manufactured to form a unitary piece.

In some implementations, the cleaning blades 800a-b can couple without a coupling component. For instance, the cleaning blades 800a-b can be manufactured to couple together in a manner that holds the two cleaning blades 800a-b together. In these implementations, the cleaning blades 800a-b can be separated along a large plane, e.g., as shown; a smaller plane, e.g., that runs the width W₂ of the cleaning blades; or some combination of both.

The tips 802 of the cleaning blades 800a-b can have any appropriate shape. For example, the tips 802 can have a point, be a blunt edge, or have another appropriate shape. When one or both of the cleaning blades 800a-b are trapezoidal in shape, the corresponding tips 802 can be blunt edges. By using a blunt edge, the cleaning blade 800a-b can increase safety, e.g., by reduced risk of harm to a person or another object.

The tips of the cleaning blades 800a-b can have different shapes. For instance, a first tip can form a point while a second tip can have a blunt edge. The blunt edge can be any appropriate shape, e.g., approximately flat or curved.

The tips of the cleaning blades 800a-b can be at any appropriate position with respect to the other tip. For instance, a first tip can be distanced apart from a second tip, e.g., along a longitudinal axis of the cleaning blades 800a-b. In some examples, a first tip 802a can be adjacent to a second tip 802b. In these examples, the edges of the tips can form an approximately flat surface, e.g., when both tips 802a-b have the same angle. The approximately flat surface can allow for manufacturing tolerances, imperfections, or both.

The angles described with respect to the surfaces, tips, or both, can be beveled.

At least one of the cleaning blades 800a-b can include an aperture 804. The cleaning blade can be formed with the aperture 804, e.g., using a mold. The cleaning blade can have the aperture 804 formed in it, e.g., using a milling process.

The aperture 804 can have any appropriate dimensions, e.g., a depth D, a width W, a radius R, or any combination of these. In some instances, the angles of the surfaces of the aperture can have substantially ninety-degree angles, e.g., and not have any radius R. The depth D and the width W can be substantially the same. The depth D and the width W can be different. The depth D, the width W, or both, can be between 10 and 85 mils, between 10 and 55 mils, between 10 and 35 mils, 22 mils, or 31 mils.

The width W, the depth D, or both, can have a size selected given a ratio to the discharge wire thickness. For instance, the ratio can be between approximately 1 and 2, between 1.25 and 1.75, between 1.4 and 1.7, e.g., approximately 1.63 with the wire having the smaller measurement.

The radius can be any appropriate value. The radius can be selected given the size of the discharge wire, the ratio, or both. In some instances, the radius can be between 10 and 75 mils, between 10 and 50 mils, between 10 and 30 mils, e.g., 16 mils.

When the comestible processing system 600 detects a jam at the discharge wire 602, the comestible processing system 600 can trigger one or more operations to remove the jam. This can increase a likelihood that the jam is removed from the processing comestible conveyors and place the previously jammed material onto a discharge conveyor or is otherwise removed from the processing conveyors.

For instance, upon receiving the signal indicating a jam, the comestible processing system 600 can send a first instruction to a first actuator for the discharge wire 602. The actuator can reposition the discharge wire 602 in a discharge position away from the discharge wire's 602 processing position. For instance, the actuator can raise the discharge wire 602, the wire cleaning apparatus 604, or both, away from the comestible processing conveyor.

The comestible processing system can send a second instruction to one or more second actuators for downstream components of the comestible processing system 700. The second instruction can cause the one or more second actuators to create an aperture 624, shown in FIG. 7J, that receives the obstruction, e.g., that caused the jam, other obstructions, e.g., caused by an initial obstruction, or both. The other obstructions can be a group of defective comestibles, e.g., malformed comestibles or comestibles stuck together, that were caused by an initial obstruction, e.g., an initial defective comestibles. In some instances, the obstruction can be a malformed comestible caused by the comestible moving from the first conveyor belt 702a to the second conveyor belt 702b with out the use of the wire 706. For instance, the downstream components can include one or more downstream comestible conveyor belts 702c-d. The one or more second actuators can cause at least one of the downstream comestible conveyor belts 702c-d, e.g., 702c, to move along a longitudinal axis. The longitudinal axis can define a direction along which comestibles are conveyed as part of comestible processing. The movement along the longitudinal axis, whether in the direction of comestible movement, opposite the direction of comestible movement, or both, when moving two downstream comestible conveyor belts in opposite directions, creates an aperture 710 between two sequential conveyor belts 702c-d. At least one of the two sequential conveyor belts 702c-d, e.g., 702c, is moved. The obstruction that causes the jam, and optionally other obstructions or malformed comestibles, falls into the aperture 710 and is removed from the processing comestible conveyors.

The comestible processing system 700 can include, or be coupled to, any appropriate device onto which the obstruction falls. For instance, the obstruction can fall into a bucket, onto a floor, onto a discharge conveyor, or different obstructions can fall onto some combination of these.

The comestible processing system 700 can continue a comestible forming process. This can include sending a third instruction to the one or more second actuators for the downstream components. The third instruction can cause the one or more second actuators to remove the aperture 710 that receives the obstruction. The third instruction can cause the one or more second actuators to move at least one of the downstream comestible conveyor belts 702c-d, e.g., 702c, so that the downstream comestible conveyor belts 702c-d are within a threshold distance of each other, enabling transfer of a comestible between the downstream comestible conveyor belts 702c. This can place the comestible processing system 700 in one of the configurations shown in FIGS. 7A-F, e.g., depending on the timing of the processing.

FIGS. 9A-C depict an example of a portion of a comestible processing system 900. The comestible processing system 900 can include one or more linear cleaning shuttles 902. Each of the linear cleaning shuttles 902 can couple with a track 904, and a wire cleaning apparatus 906. The track 904 couples with a frame 908 of the comestible processing system 900. The track 904 can removably couple with the frame 908. In some implementations, the track 904 can fixedly couple with the frame 908.

A linear cleaning shuttle 902 moves across the track 904. The linear cleaning shuttle 902 can include or otherwise couple with an actuator that moves the linear cleaning shuttle 902 across the track 904. A controller in the comestible processing system 900 can send a command to the actuator that causes the actuator to move the linear cleaning shuttle 902, and the corresponding wire cleaning apparatus 906, longitudinally across the track 908. The wire cleaning apparatus 906 includes one or more cleaning blades 914, e.g., two or more blades, as shown in FIGS. 9B-C.

In some implementations, the comestible processing system 900 includes multiple tracks 904, multiple linear cleaning shuttles 902, or a combination of both. The comestible processing system 900 includes one wire cleaning apparatus for each linear cleaning shuttle 902. The comestible processing system 900 can include two linear cleaning shuttles 902 that both couple with the same or different tracks 904. This can enable a faster cleaning of a discharge wire.

The comestible processing system 900 can include a discharge wire 910, a discharge wire mount 912, or both. The discharge wire mount 912, as shown in FIG. 9A, can be removably coupled, e.g., securely coupled, with the frame 908. The discharge wire 910 can be removably coupled to the discharge wire mount 912, e.g., and a second discharge wire mount 912 on the opposite side of the frame 908.

The discharge wire 910 can be replaced. For instance, the discharge wire 910 can be replaced according to a schedule, periodically, when an old discharge wire breaks, when a discharge wire is predicted to break, or any combination of these.

The discharge wire 910 can be replaced using any appropriate process. The process can be a manual process, an automated process, or a combination of both. For instance, for the replacement process, one or more fasteners included in the discharge wire mount 912 can be loosened to allow an old discharge wire to be removed, e.g., manually or automatically, from the comestible processing system.

A new discharge wire 910 can be secured to the one or more fasteners in the discharge wire mount 912. In implementations in which the discharge wire 910 is continuous, e.g., feeds from a spool on one side of the frame 908, the new discharge wire 910 can be cut to remove a used portion of the new discharge wire. The new discharge wire 910 need not be secured to the discharge wire mount 912 using the one or more fasteners.

The new discharge wire 910 can be placed through the aperture in one or more cleaning blades. When there is a single cleaning blade, the discharge wire 910 can be placed through the aperture in the single cleaning blade. When there are two or more cleaning blades, at least some of the cleaning blades can be positioned in a wire replacement position to enable access to the aperture. With access to the aperture enabled, the discharge wire 910 can be placed in the aperture. The cleaning blades can be returned to a processing position.

Once the discharge wire 910 is positioned in the aperture, the wire cleaning apparatus 906, e.g., operating as a wire fixture to retain the discharge wire 910 in place, can traverse the track 904. For instance, the comestible processing system can send a command to the actuator for the linear cleaning shuttle 902 that causes the linear cleaning shuttle 902 to traverse the track 904. This can cause the linear cleaning shuttle to move from a first position within a threshold distance of a first side of the frame 908 to a second position within a threshold distance of a second, opposite side of the frame 908. The opposite end of the new discharge wire 910 that is not already secured to the discharge wire mount 912 can be secured to a second discharge wire mount 912 on the opposite side of the frame 908.

In some implementations, the comestible processing system 900 can adjust a position of the discharge wire 910, the wire cleaning apparatus 906, or both. This adjusted position can be with respect to the frame 908 or another reference point other than the conveyor belt 916. The comestible processing system 900 can detect changes in thickness in the conveyor belt 916. In response, the comestible processing system 900 can adjust the position of the discharge wire 910. This can reduce wear on the discharge wire 910, the conveyor belt 916, or both. The change in thickness of the conveyor belt 916 can be caused by a pin or another fastener that secures ends of the conveyor belt.

The one or more cleaning blades can have any appropriate orientation. The cleaning blades can point up. The cleaning blades can point down. The cleaning blades can point upstream. The cleaning blades can point downstream. The cleaning blades can point in any direction that is a combination of two or more of these. In some instances, the cleaning blades might not point in any direction, e.g., when the cleaning blade has a homogenous body.

The comestible processing system 900 can include one or more cleaning devices 918 for the cleaning blades 914. For instance, the cleaning devices 918 can blow air onto; draw material from, e.g., using vacuum; or both; the cleaning blades 914 to remove any accumulation, e.g., of debris, from the cleaning blades 914.

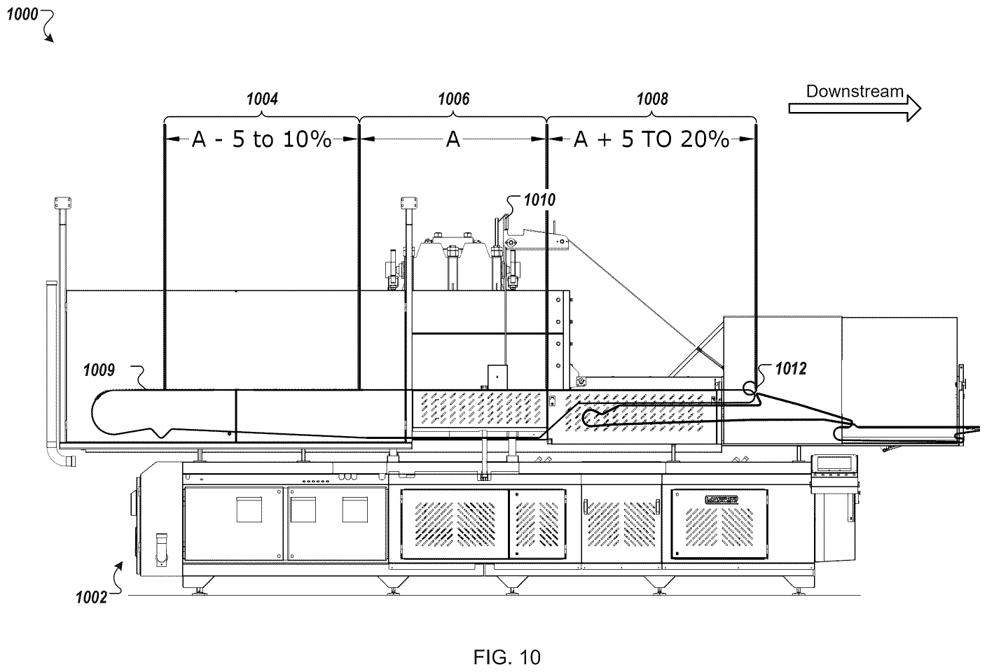

FIG. 10 depicts an example press 1000 that can be included in a comestible processing system. The press 1000 includes a support frame 1002. The support frame 1002 can include a press area 1006 and a discharge area 1008 for a conveyor belt 1009. The press area 1006 has a size A selected in part based on a pressing pattern size during a press cycle. The pressing pattern can be selected based in part on the size of the comestibles, e.g., a diameter of the comestible, a number of comestibles in each pressing pattern, a separation between comestibles after the pressing. Some example pressing pattern layouts can be 3×3, 4×4, 5×5, and 5×6, in which each dimension is a number of comestibles, e.g., three comestibles by three comestibles for a 3×3 pressing pattern layout. During a press cycle, a press forms a group of comestibles, e.g., 9 comestibles, 12 comestibles, 16 comestibles, 25 comestibles, and the like, pressured during the press cycle.

The pressing pattern size can be a longitudinal distance in the press 1000 that accommodates the pressing pattern layout. For instance, to press a group of comestibles in a 5×5 pressing pattern layout, the press 1000 might need a 60×60 inch press head 1010, e.g., depending on the diameter of the comestibles after a press process. This pressing pattern size can enable forming of the comestibles with a target diameter while leaving space between adjacent comestibles, e.g., so adjacent comestibles are less likely to get stuck together.

In some instances, the pressing pattern size can be fixed for a particular press 1000. In these instances, when the press processing smaller diameter comestibles, the press 1000 can use a larger pressing pattern layout, e.g., that forms more comestibles during a press cycle; have a different, e.g., larger, space between adjacent comestibles; or both.

The discharge area 1008 downstream from the press area 1006 has a size selected in part based on a combination of the pressing pattern size for the group of comestibles pressed during a press cycle and a target distance between a leading edge of a leading set of comestibles and the discharge wire. For instance, the discharge area 1008 can have a size that is greater than the press area 1006 size A by between five to twenty percent, e.g., inclusive or exclusive. The leading set of comestibles can be the row of one or more comestibles in the pressing pattern layout that are further downstream than the other comestibles in the pressing pattern layout, e.g., that are closest to the discharge wire 1012. The press area 1006 can have a length dimension along the movement of the conveyor of, for example, 60 inches, 60.5 inches, 61 inches, 62 inches, or the like, e.g., based on the size of the press head 1010. The discharge area 1008 can have a length dimension along the movement of the conveyor of that is longer than the length of the press area 1006, for example 62 inches, 63 inches, 64 inches, 65 inches, or the like.

In some implementations, the press area 1006 is a square area, e.g., 52×52 square inches, 60×60 square inches, and the discharge area 1008 is rectangular, e.g., 64.25 inches×60 inches, 56.25 inches×52 inches, and the like.

In some implementations, a target distance between the leading edge of a leading set of comestibles, e.g., the set of one or more comestibles that exit the press area and enter the discharge area first, and the discharge wire 1012 is selected in part such that the leading edge of a leading set of comestibles reaches at least a threshold velocity when contacting the discharge wire. The target distance to reach the threshold velocity of the leading edge can depend in part on a maximum available acceleration of the conveyor belt for a given static friction between a bottom surface of the comestibles and the conveyor belt. For example, a maximum acceleration can be set such that the comestibles are not likely to slide with respect to the conveyor belt when the conveyor belt accelerates to reach the threshold velocity.

In some implementations, the press area 1006 and the discharge area 1008 can be different sizes, e.g., different in length along the direction of travel of the conveyor belt. The discharge area 1008 can be longer than the press area 1006 by a difference in length, e.g., by five to twenty percent. In some examples, the difference can be a difference in length equal to a distance required to accelerate the leading edge of the leading set of comestibles to the target velocity. For example, a difference between a length of the discharge area 1008 and the press area 1006 can be between two and four and a half inches.

In some implementations, the support frame 1002 of the comestible processing system includes a loading area 1004. The loading area 1004 can be upstream of the press area 1006 and configured to accommodate pre-pressed comestibles in the loading area 1004 prior to the pressing process. A size of the loading area 1004 can be selected based in part on the pressing pattern, e.g., where the pre-pressed comestibles are arranged in the loading area 1004 based on the pressing pattern. For example, the size of the loading area 1004 can be approximately the same as the size of the press area 1006 based on the pressing pattern size, e.g., where the size of the loading area 1004 is the same as the size of the press area 1006. The longitudinal length of the size of the loading area 1004 can be plus or minus five to ten percent of the size A of the press area 1006, e.g., the longitudinal length of the press area 1006.

In this specification, the term likely can mean that there is a likelihood that something might occur and that the likelihood satisfies a likelihood threshold. For instance, when determining whether a comestible will likely slide, a system would determine a likelihood that the comestible will slide. The system would then determine whether the likelihood satisfies, e.g., is greater than or equal to, a likelihood threshold by comparing the two values. If so, the system determines that the comestible will likely slide. If not, the system determines that the comestible will not likely slide.

A number of implementations have been described. Nevertheless, it will be understood that various modifications may be made without departing from the spirit and scope of the disclosure. For example, various forms of the flows shown above may be used, with operations re-ordered, added, or removed.

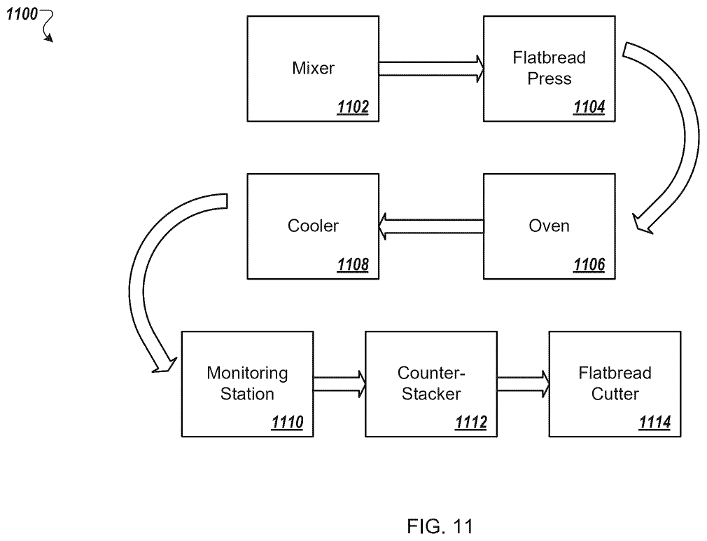

FIG. 11 depicts an example of some devices that can be included in a flatbread processing system 1100, e.g., a comestible processing system. The flatbread processing system 1100 can be used to process the comestibles described above with reference to FIGS. 1, 2, 3A-C, and 4A-E. The flatbread processing system 1100 does not depict all devices that could be included in a system, depending on system configuration, such as a dough ball loader that forms balls of dough from batter created by a mixer 1102 and places the dough balls on the flatbread press 1104, e.g., a forming press, using a comestible loader.

The flatbread processing system 1100 includes a mixer 1102. The mixer 1102 combines multiple ingredients according to a process recipe. The mixer 1102 mixes the multiple ingredients to create a dough batter.

The mixer 1102 can be connected to a former (not shown) that creates dough balls from the batter created by the mixer 1102. The former can place the dough balls in a dough ball loader that is configured according to a pressing pattern layout for the flatbread being made by the flatbread processing system 1100. The pressing pattern layout can be any appropriate type of pattern, e.g., 3×3, 4×4, 5×5, or 5×6. The former selects an amount of batter based on a threshold comestible size range for the dough balls, e.g., to create 10 inch tortillas or 8 inch tortillas. The threshold comestible size range can be a comestible parameter, e.g., specified by the process recipe.

The dough ball loader can place the dough balls on a conveyor included in the flatbread press 1104. Once a dough ball is placed on a location on an upper surface of the conveyor for each of the locations in a pressing pattern layout, e.g., a 3×3 pressing pattern layout, the flatbread press 1104 moves the conveyor forward to place the dough balls under the press. The flatbread press 1104 then presses the dough balls. During the pressing operation, the flatbread press 1104 can slightly bake the dough balls to increase a likelihood that the pressed dough balls will maintain their pressed shape.

The processing of the dough balls in the pressing pattern layout can be a press cycle. For instance, when the pressing pattern is 3×3, the pressing operation of the 3×3 dough balls can be a single press cycle for the flatbread press 1104.

The flatbread press 1104 can then transfer the pressed dough balls to a discharge station included in the flatbread press 1104. The discharge station can include a heater to parbake the pressed dough balls. Use of the discharge station can enable the flatbread press 1104 to use a lower temperature during the pressing process.

The flatbread processing system 1100 then transfers the pressed dough balls from the flatbread press 1104 to an oven 1106. The flatbread processing system 1100 can use one or more conveyors to transfers the dough balls from the flatbread press 1104 to the oven 1106.

The oven 1106 includes one or more oven conveyors that transfer the pressed dough balls through the oven 1106 during a cooking process. As the one or more conveyors transfer the pressed dough balls through the oven 1106, the pressed dough balls are cooked so that when the pressed dough balls exit the oven 1106, the cooking process is likely complete. In some implementations, the pressed dough balls can proceed to another cooking process after removal from the oven 1106.

After cooking, the flatbread processing system 1100 can transfer the cooked, pressed dough balls onto one or more conveyors to transfer the pressed dough balls from the oven 1106 to a cooler 1108. In some implementations, the flatbread processing system 1100 can use one or more conveyors that transfer the pressed dough balls to an upper portion of the cooler 1108.

The cooler 1108 can include multiple cooling conveyors that transport the pressed dough balls through the cooler 1108. The cooler 1108 can use any appropriate process, components, or both, to reduce the temperature of the pressed dough balls. For instance, as the pressed dough balls move through the cooler 1108, air can move across the surfaces of the pressed dough balls to cool the pressed dough balls to a reduced temperature.

In some implementations, the pressed dough balls can have a temperature close to 200° F. when entering the cooler 1108. The cooler can include one or more fans to move air from an environment outside of the cooler 1108 (e.g., at an ambient temperature between about 65 to about 80° F.) across the cooling conveyors and the pressed dough balls. As the air passes across the pressed dough balls, heat is removed from the pressed dough balls and the pressed dough balls are cooled.

The flatbread processing system 1100 transfers the pressed dough balls from the cooler to a monitoring station 1110. The monitoring station 1110 can analyze one or more properties of the pressed dough balls, including the diameter and color. For instance, the monitoring station 1110 can determine whether a pressed dough ball was burnt, conforms with size requirements for a process recipe for the pressing pattern, or both. In general, the monitoring station 1110 can determine whether the pressed dough ball substantially conforms with one or more threshold comestible parameters for the process recipe.

The monitoring station 1110 can include a dough ball removal device used to remove dough balls from the monitoring station 1110 that do not conform to predetermined criteria for the recipe. For instance, the monitoring station can include one or more air blowers, e.g., one for each processing lane for the pressing pattern, to remove pressed dough balls that were overcooked, pressed too much, not pressed enough, or a combination of these.

The flatbread processing system 1100 transfers the pressed dough balls that conform to the predetermined criteria to a counter-stacker 1112. The counter-stacker 1112 can create stacks of pressed dough balls based on a stack quantity identified in the recipe for the flatbread processing system 1100.

The flatbread processing system 1100 transfers stacks of pressed dough balls to a bagger 1114 that places each stack into a bag. The bagged stack of pressed dough balls can then be removed from the bagger 1114 and the flatbread processing system 1100.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a smart phone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display), OLED (organic light emitting diode) or other monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an Hypertext Markup Language (HTML) page, to a user device, e.g., for purposes of displaying data to and receiving user input from a user interacting with the user device, which acts as a client. Data generated at the user device, e.g., a result of the user interaction, can be received from the user device at the server.

In addition to the embodiments of the attached claims and the embodiments described above, the following numbered embodiments are also innovative.
Embodiment 1 is a system for processing comestibles comprising:
   a wire cleaning apparatus adapted to clean a discharge wire that is i) positioned within a threshold distance from a comestible conveyor belt and ii) adapted to remove comestibles from the comestible conveyor belt; and
   an actuator adapted to move the wire cleaning apparatus horizontally across the discharge wire during a cleaning process.
Embodiment 2 is the system of embodiment 1, further comprising a controller configured to trigger initiation of the cleaning process.
Embodiment 3 is the system of embodiment 2, wherein the controller is configured to receive a signal indicating a comestible press process and, in response to receiving the signal, trigger initiation of the cleaning process.
Embodiment 4 is the system of any one of embodiments 2 or 3, wherein the controller is configured to trigger initiation of the cleaning process every other comestible press cycle.
Embodiment 5 is the system of any one of embodiments 2 to 4, wherein the controller is configured to trigger initiation of the cleaning process every twentieth comestible press cycle.
Embodiment 6 is the system of any one of the preceding embodiments, wherein the actuator is adapted to move the wire cleaning apparatus from a first side of the comestible conveyor belt to a second side of the comestible conveyor belt during a first cleaning process and, after the discharge wire removes one or more comestibles from the comestible conveyor belt and for a second cleaning process, from the second side of the comestible conveyor belt to the first side of the comestible conveyor belt.
Embodiment 7 is the system of any one of the preceding embodiments, comprising:
   a sensor configured to detect an obstruction along the discharge wire and, in response to detecting an obstruction along the discharge wire, transmit, to a controller, a signal that indicates that the obstruction was detected.
Embodiment 8 is the system of embodiment 7, comprising the controller configured to transmit, in response to receipt of the signal that indicates that the obstruction was detected, a second signal that causes one or more portions of a comestible processing system to change function.
Embodiment 9 is the system of embodiment 8, wherein the second signal causes a portion of the comestible processing system that is downstream from the wire cleaning apparatus and the actuator to create an aperture that receives the obstruction to remove the obstruction from a conveyor belt.
Embodiment 10 is the system of any one of embodiments 8 or 9, comprising a second actuator adapted to, in response to receipt of the second signal, move the wire cleaning apparatus and the discharge wire to a discharge position away from the comestible conveyor belt.
Embodiment 11 is the system of embodiment 10, wherein the second actuator is adapted to reposition the wire cleaning apparatus and the discharge wire in a processing position that positions the discharge wire within the threshold distance from the comestible conveyor belt after a press cycle that includes the obstruction is removed from the comestible conveyor belt.
Embodiment 12 is the system of any one of embodiments 8 to 11, wherein the second signal causes the one or more portions of the comestible processing system to stop.
Embodiment 13 is the system of any one of embodiments 7 to 12, wherein the obstruction comprises a comestible that is at least indirectly stuck on the discharge wire.
Embodiment 14 is the system of any one of embodiments 7 to 13, wherein the sensor comprises a laser photo eye.
Embodiment 15 is the system of any one of embodiments 7 to 14, wherein the sensor is configured to monitor a portion of a length of the discharge wire.
Embodiment 16 is the system of any one of embodiments 1 to 15, wherein the wire cleaning apparatus comprises a wire cleaning edge adapted to remove debris from the discharge wire.
Embodiment 17 is the system of embodiment 16, wherein:
   the discharge wire comprise a first longitudinal axis that is approximately perpendicular to a second longitudinal axis the comestible conveyor belt along which the comestible conveyor belt is adapted to move comestibles; and
   the wire cleaning edge is positioned at an angle with respect to the first longitudinal axis of the discharge wire.
Embodiment 18 is the system of embodiment 17, wherein the angle is between zero and ninety degrees.

Embodiment 19 is the system of any one of embodiments 16 to 18, wherein the wire cleaning apparatus comprises a cleaning blade that (i) includes the wire cleaning edge and a second wire cleaning edge and (ii) has a polygonal shape formed in part by the wire cleaning edge and the second wire cleaning edge.
Embodiment 20 is the system of any one of embodiments 16 to 19, wherein the wire cleaning apparatus comprises a cleaning blade that (i) includes the wire cleaning edge and a second wire cleaning edge and (ii) has a trapezoidal shape formed in part by the wire cleaning edge and the second wire cleaning edge.
Embodiment 21 is the system of any one of embodiments 19 or 20, wherein the cleaning blade comprises a third short edge opposite an arm included in the wire cleaning apparatus.
Embodiment 22 is the system of any one of the preceding embodiments, wherein the wire cleaning apparatus comprises at least one cleaning blade.
Embodiment 23 is the system of embodiment 22, wherein the wire cleaning apparatus comprises a first cleaning blade adapted to couple with a second cleaning blade to form an aperture adapted to pass across the discharge wire during a cleaning process.
Embodiment 24 is the system of embodiment 23, wherein the wire cleaning apparatus comprises an arm adapted to couple to a) the first cleaning blade and the second cleaning blade and b) a linear cleaning shuttle adapted to move the wire cleaning apparatus across the discharge wire during the cleaning process.
Embodiment 25 is the system of embodiment 24, comprising the linear cleaning shuttle adapted to couple to the arm and a support frame.
Embodiment 26 is the system of embodiment 25, comprising the support frame.
Embodiment 27 is the system of any one of the preceding embodiments, wherein the wire cleaning apparatus is adapted to clean the discharge wire that is i) positioned within the threshold distance from a first comestible conveyor belt and ii) adapted to remove comestibles from the first comestible conveyor belt for transport onto a second comestible conveyor belt.
Embodiment 28 is the system of any one of the preceding embodiments, comprising:
   a sensor configured to detect a deformation in the discharge wire and, in response to detecting the deformation in the discharge wire, transmit, to a controller, a signal that indicates that the discharge wire is deformed.
Embodiment 29 is the system of embodiment 28, wherein the sensor comprises a laser photo eye or a camera.
Embodiment 30 is the system of any one of embodiments 28 to 29, wherein the sensor is configured to monitor a portion of a length of the discharge wire.
Embodiment 31 is the system of any one of the preceding embodiments, comprising a support frame that comprises a first roller and a second roller, the first roller and the second roller adapted to support the comestible conveyor belt that i) moves a plurality of comestibles and ii) has an outer surface adapted to support the plurality of comestibles, at least one of the first roller or the second roller comprising an active roller coupled to a second actuator adapted to rotate the roller and move the comestible conveyor belt.
Embodiment 32 is the system of embodiment 31, wherein the support frame comprises:
   a press area with a first size based on a pressing pattern size during a press cycle, and at which a press forms a group of comestibles in a pressing pattern having the pressing pattern size during the press cycle; and
   a discharge area downstream from the press area and with a second size that is based on a combination of the pressing pattern size for the group of comestibles pressed during a press cycle and a target distance between a leading edge of a comestible and the discharge wire.
Embodiment 33 is the system of embodiment 32, the target distance selected so that the leading edge of the comestible reaches at least a threshold velocity when contacting the discharge wire.
Embodiment 34 is the system of any one of embodiments 32 to 33, wherein the second size is between five and twenty percent greater than the first size, or a difference between the first size and the second size is between two to four and a half inches.
Embodiment 35 is the system of any one of embodiments 32 to 34, comprising the conveyor belt and one or more actuators adapted to move the conveyor belt in a downstream direction by an amount based on a longitudinal distance of the press pattern and a longitudinal distance of a seam in the conveyor belt.
Embodiment 36 is the system of any one of embodiments 32 to 35, comprising a loading area upstream from the press area, and with a third size that is approximately the same as the first size based on the pressing pattern size.
Embodiment 37 is the system of embodiment 36, wherein the third size is between five percent greater and five percent less than the first size, or the first size is the same as the third size.
Embodiment 38 is the system of any one of the preceding embodiments, comprising:
   the discharge wire adapted to connect to the support frame and adapted to remove comestibles from the comestible conveyor belt.
Embodiment 39 is the system of any one of the preceding embodiments,, comprising a press adapted to process the plurality of comestibles while the plurality of comestibles are on respective portions of the outer surface.
Embodiment 40 is the system of any one of the preceding embodiments, comprising:
   a loader adapted to couple with the support frame and place the plurality of comestibles on the outer surface of the comestible conveyor belt before the discharge wire; and
   a second comestible conveyor belt adapted to receive at least some of the plurality of comestibles from the comestible conveyor belt after the discharge wire removes the comestibles from the comestible conveyor belt.
Embodiment 41 is the system of any one of the preceding embodiments, comprising a second actuator adapted to first move the wire cleaning apparatus to contact the discharge wire at a beginning of the cleaning process and second move the wire cleaning apparatus away from the discharge wire at an end of the cleaning process.
Embodiment 1B is a system for processing comestibles comprising:
   a wire fixture adapted to attach, at a position on a support frame that is within a threshold distance from a comestible conveyor belt, a discharge wire that is adapted to remove comestibles from the comestible conveyor belt; and
   an actuator adapted to move the wire fixture horizontally across the discharge wire during a wire mounting process.
Embodiment 2B is the system of embodiment 1B, comprising a controller configured to trigger initiation of the wire mounting process.
Embodiment 3B the system of any one of embodiments 1B to 2B, wherein the actuator is adapted to move the wire fixture from a first side of the comestible conveyor belt to a second side of the comestible conveyor belt during the wire mounting process while a first end of the discharge wire is coupled to the support frame and a second end of the discharge wire is coupled to the wire fixture.
Embodiment 4B is the system of embodiment 3B, comprising:
   a connection module adapted to connect the second end of the discharge wire with the support frame.
Embodiment 5B is the system of embodiment 4B, wherein the connection module comprises an air cylinder.
Embodiment 6B is the system of embodiment 4B, wherein the connection module comprises a pneumatic cylinder.
Embodiment 7B is the system of embodiment 4B, wherein the connection module comprises a hydraulic cylinder.
Embodiment 8B is the system of claim 4B, wherein the connection module comprises a second actuator.
Embodiment 9B is the system of any of embodiments 1B to 8B, comprising:
   a sensor configured to detect when a prior discharge wire breaks and, in response to detecting that the prior discharge wire broke, transmit, to a controller, a signal that initiates the wire mounting process.
Embodiment 10B is the system of embodiment 9B, comprising the controller configured to transmit, in response to receipt of the signal that initiates the wire mounting process, a second signal that causes one or more portions of a comestible processing system that includes the support frame to stop.
Embodiment 11B is the system of any of embodiments 9B to 10B, wherein the sensor comprises a laser photo eye.
Embodiment 12B is the system of any of embodiments 9B to 11B, wherein the sensor is configured to monitor a portion of a length of the discharge wire.
Embodiment 13B is the system of any of embodiments 1B to 12B, comprising the support frame that comprises a first roller and a second roller, the first roller and the second roller adapted to support the comestible conveyor belt that i) moves a plurality of comestibles and ii) has an outer surface adapted to support the plurality of comestibles, at least one of the first roller or the second roller comprising an active roller coupled to a second actuator adapted to rotate the active roller and move the comestible conveyor belt.
Embodiment 14B is the system of any of embodiments 1B to 13B, comprising:
   the discharge wire adapted to connect to the support frame and adapted to remove comestibles from the comestible conveyor belt.
Embodiment 15B is the system of any of embodiments 1B to 14B, comprising a press adapted to process the plurality of comestibles while the plurality of comestibles are on respective portions of the outer surface of the comestible conveyor belt.
Embodiment 11B is the system of any of embodiments 1B to 15B, comprising:
   a loader adapted to couple with the support frame and place the plurality of comestibles on the outer surface of the comestible conveyor belt before the discharge wire; and
   a second comestible conveyor belt adapted to receive at least some of the plurality of comestibles from the comestible conveyor belt after the discharge wire removes the comestibles from the comestible conveyor belt.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the invention have been described. Other embodiments are within the scope of the following claims. For example, the operations recited in the claims, described in the specification, or depicted in the figures can be performed in a different order and still achieve desirable results. In some cases, multitasking and parallel processing may be advantageous.

What is claimed is:

1. A system for processing comestibles comprising:
a wire cleaning apparatus adapted to clean a discharge wire that is i) positioned within a threshold distance from a comestible conveyor belt and ii) adapted to remove comestibles from the comestible conveyor belt; and
an actuator adapted to move the wire cleaning apparatus horizontally across the discharge wire during a cleaning process.

2. The system of claim 1, comprising a controller configured to trigger initiation of the cleaning process.

3. The system of claim 2, wherein the controller is configured to receive a signal indicating a comestible press process and, in response to receiving the signal, trigger initiation of the cleaning process.

4. The system of claim 1, wherein the actuator is adapted to move the wire cleaning apparatus from a first side of the comestible conveyor belt to a second side of the comestible conveyor belt during a first cleaning process and, after the discharge wire removes one or more comestibles from the comestible conveyor belt and for a second cleaning process, from the second side of the comestible conveyor belt to the first side of the comestible conveyor belt.

5. The system of claim 1, comprising:
a sensor configured to detect an obstruction along the discharge wire and, in response to detecting an obstruction along the discharge wire, transmit, to a controller, a signal that indicates that the obstruction was detected.

6. The system of claim 5, comprising the controller configured to transmit, in response to receipt of the signal that indicates that the obstruction was detected, a second signal that causes one or more portions of a comestible processing system to change function.

7. The system of claim 6, wherein the second signal causes a portion of the comestible processing system that is downstream from the wire cleaning apparatus and the actuator to create an aperture that receives the obstruction to remove the obstruction from a conveyor belt.

8. The system of claim 7, comprising a second actuator adapted to, in response to receipt of the second signal, move the wire cleaning apparatus and the discharge wire to a discharge position away from the comestible conveyor belt.

9. The system of claim 8, wherein the second actuator is adapted to reposition the wire cleaning apparatus and the discharge wire in a processing position that positions the discharge wire within the threshold distance from the comestible conveyor belt after a press cycle that includes the obstruction is removed from the comestible conveyor belt.

10. The system of claim 1, wherein the wire cleaning apparatus comprises a wire cleaning edge adapted to remove debris from the discharge wire.

11. The system of claim 10, wherein:
the discharge wire comprise a first longitudinal axis that is approximately perpendicular to a second longitudinal axis the comestible conveyor belt along which the comestible conveyor belt is adapted to move comestibles; and
the wire cleaning edge is positioned at an angle with respect to the first longitudinal axis of the discharge wire.

12. The system of claim 1, wherein the wire cleaning apparatus comprises at least one cleaning blade.

13. The system of claim 12, wherein the wire cleaning apparatus comprises a first cleaning blade adapted to couple with a second cleaning blade to form an aperture adapted to pass across the discharge wire during a cleaning process.

14. The system of claim 13, wherein the wire cleaning apparatus comprises an arm adapted to couple to a) the first cleaning blade and the second cleaning blade and b) a linear cleaning shuttle adapted to move the wire cleaning apparatus across the discharge wire during the cleaning process.

15. The system of claim 1, wherein the wire cleaning apparatus is adapted to clean the discharge wire that is i) positioned within the threshold distance from a first comestible conveyor belt and ii) adapted to remove comestibles from the first comestible conveyor belt for transport onto a second comestible conveyor belt.

16. The system of claim 1, comprising:
a sensor configured to detect a deformation in the discharge wire and, in response to detecting the deformation in the discharge wire, transmit, to a controller, a signal that indicates that the discharge wire is deformed.

17. The system of claim 1, comprising a support frame that comprises a first roller and a second roller, the first roller and the second roller adapted to support the comestible conveyor belt that i) moves a plurality of comestibles and ii) has an outer surface adapted to support the plurality of comestibles, at least one of the first roller or the second roller comprising an active roller coupled to a second actuator adapted to rotate the roller and move the comestible conveyor belt.

18. The system of claim 17, wherein the support frame comprises:
a press area with a first size based on a pressing pattern size during a press cycle, and at which a press forms a group of comestibles in a pressing pattern having the pressing pattern size during the press cycle; and
a discharge area downstream from the press area and with a second size that is based on a combination of the pressing pattern size for the group of comestibles pressed during a press cycle and a target distance between a leading edge of a comestible and the discharge wire.

19. The system of claim 18, the target distance selected so that the leading edge of the comestible reaches at least a threshold velocity when contacting the discharge wire.

20. The system of claim 17, comprising a press adapted to process the plurality of comestibles while the plurality of comestibles are on respective portions of the outer surface.
